(19) United States
(12) Patent Application Publication
(10) Pub. No.: US 2015/0278974 A1
(43) Pub. Date: Oct. 1, 2015

(54) SYSTEMS AND METHODS FOR DETERMINING AND COMMUNICATING A LOST REVENUE OPPORTUNITY

(71) Applicant: MCKESSON CORPORATION, San Francisco, CA (US)

(72) Inventors: Gregory Doerr, West Chicago, MN (US); Julie Sperling, Greenfield, MN (US); Michael Schlecht, Minneapolis, MN (US); Timothy Quast, Appley Valley, MN (US)

(73) Assignee: MCKESSON CORPORATION, San Francisco, CA (US)

(21) Appl. No.: 14/230,369

(22) Filed: Mar. 31, 2014

(51) Int. Cl. G06Q 50/22; G06Q 10/06; G06Q 30/04

(52) U.S. Cl. CPC G06Q 50/22; G06Q 30/04; G06Q 10/06395

(57) ABSTRACT

Systems and methods for determining and communicating lost revenue opportunity associated with dispensing data and/or billing data corresponding to an outpatient pharmacy transaction. Dispensing data and billing data may be received by the service provider computer from a healthcare provider computer. The service provider computer may load the dispensing data and the billing data into a target dispensing data table and a target billing data table, respectively. The service provider computer may identify one or more data events corresponding to the target dispensing data table and/or the target billing data table. The service provider computer may determine one or more lost revenue opportunities for the identified data events. The service provider computer may generate a lost revenue report including the determined lost revenue opportunities, and communicate the lost revenue report to the healthcare provider computer.

### TECHNICAL FIELD

Aspects of the disclosure relate generally to revenue opportunities and more particularly to systems and methods for determining and communicating a lost revenue opportunity corresponding to an outpatient pharmacy transaction.

### BACKGROUND

In today's complex healthcare systems, hospitals can struggle to maintain the accuracy of their hospital financial systems, making it difficult to efficiently identify revenue issues within the system. For example, a hospital may lose valuable dollars associated with a hospital pharmacy due to inaccurate billing and/or failure to bill at all. While most hospitals are aware of the lost revenue, the pharmacy is typically disconnected from the hospital financial system and therefore the hospital does not know how to identify the potential opportunities and/or the revenue that the hospital may be losing. Accordingly, there is a need for systems and methods to identify lost revenue opportunities for healthcare transactions associated with a hospital pharmacy.

### BRIEF DESCRIPTION OF THE DRAWINGS

Reference will now be made to the accompanying drawings, which are not necessarily drawn to scale, and wherein:

FIGS. 1A and 1B illustrate an example system for facilitating, among other things, determining and communicating a lost revenue opportunity corresponding to an outpatient pharmacy transaction, according to one exemplary embodiment.

FIG. 2 illustrates a flow chart of an example method for creating and/or storing a target prescription data table and/or a target billing data table corresponding to prescription dispensing data and/or prescription billing data for outpatient pharmacy transactions, according to an example embodiment.

FIG. 3 illustrates a flow chart of an example method for determining lost revenue for a medication and/or product that was dispensed but incorrectly billed as part of an outpatient pharmacy transaction, according to an example embodiment.

FIG. 4 illustrates a flow chart of an example method for determining lost revenue for a medication and/or product that was dispensed but was not billed as part of an outpatient pharmacy transaction, according to one exemplary embodiment.

FIG. 5 illustrate a flow chart of another example method for determining lost revenue for a medication and/or product that was dispensed but was not billed as part of an outpatient pharmacy transaction, according to one exemplary embodiment.

FIG. 6 illustrates a flow chart of an example method for determining lost revenue for a medication and/or product that was improperly coded during a billing process as part of an outpatient pharmacy transaction, according to one exemplary embodiment.

FIG. 7 illustrates a flow chart of an example method for determining lost revenue for a medication and/or product as a result of failure to enter required billing data as part of an outpatient pharmacy transaction, according to one exemplary embodiment.

FIG. 8 illustrates a flow chart of an example method for determining lost revenue for a medication and/or product discarded by a provider and subsequently not billed as a part of an outpatient pharmacy transaction, according to one exemplary embodiment.

FIG. 9 illustrates a flow chart of an example method for determining lost revenue for a medication and/or product that was dispensed but not properly coded as part of an outpatient pharmacy transaction, according to one exemplary embodiment.

FIG. 10 illustrates a flow chart of another example method for determining lost revenue for a medication and/or product partially discarded by a provider and subsequently not billed as part of an outpatient pharmacy transaction, according to one exemplary embodiment.

FIG. 11 illustrates a flow chart of another example method for communicating one or more lost revenue opportunities to a healthcare provider computer, according to one exemplary embodiment.

### DETAILED DESCRIPTION OF EXEMPLARY EMBODIMENTS

Exemplary embodiments will now be described more fully hereinafter with reference to the accompanying drawings, in which exemplary embodiments are shown. The concepts disclosed herein may, however, be embodied in many different forms and should not be construed as limited to the exemplary embodiments set forth herein; rather, these embodiments are provided so that this disclosure will be thorough and complete, and will fully convey the scope of the concepts to those skilled in the art. Like numbers refer to like, but not necessarily the same or identical, elements throughout.

Exemplary embodiments described herein include systems and methods for determining and communicating lost revenue opportunities associated with dispensing data and/or billing data corresponding to an outpatient pharmacy transaction. In this regard, a lost revenue opportunity may be determined as a part of, for example, a quarterly review process conducted by a service provider to determine one or more areas a healthcare provider (e.g., hospitals and/or medical centers, urgent care facilities, home health care facilities, nursing home facilities, or the like) may be able to capture lost revenue as a result of a misbill, a failure to bill waste, and/or a failure to bill an outpatient pharmacy transaction at all.

In one example, a service provider computer for a service provider, may request prescription dispensing data and pharmacy billing data from a healthcare provider computer. In one example, the prescription dispensing data and the pharmacy billing data may be data associated with a transaction that has been communicated from a pharmacy and has not been subjected to processing or any other manipulation (e.g., raw data). The request may be communicated by the service provider computer on a scheduled interval, for example, quarterly. While the exampled described herein will reference a quarterly interval, it is understood that the interval can be varied and configurable based on the needs of the particular parties and can alternatively be daily, weekly, bi-weekly, monthly, bi-monthly, annually, semi-annually, or any other interval between one day and one year. In one example, the service provider computer may employ a data preparation module to extract, transform, and load (ETL) the raw pharmacy billing data and the raw prescription dispensing data received and/or accessed from the healthcare provider computer associated with (e.g., located at and/or providing services for) a particular healthcare provider into one or more staging tables. The data preparation module may transfer the raw prescription dispensing data in a staged dispensing data table to a target dispensing data table. The data preparation module may also transfer the raw pharmacy billing data in a staged billing data table to a target billing data table. The data preparation module may also facilitate storage of the target dispensing data table and the target billing data table in a database.

In one example, the service provider computer may employ a revenue opportunity tool module to determine whether an opportunity exists to capture revenue (e.g., funds) that may have been previously missed and/or overlooked during a billing process. The revenue opportunity tool module may utilize one or more tools to analyze dispensing data and/or billing data in the respective target dispensing data table and the target billing data table. The revenue opportunity tool module may process the dispensing data and/or the billing data through one or more filters, to filter out data that may not be utilized by a revenue opportunity tool to determine a potential revenue opportunity. The revenue opportunity tool module may process the filtered dispensing data and the filtered billing data using one or more business rules to determine a lost revenue opportunity. The service provider computer may also generate a lost revenue report that includes lost revenue opportunities determined by the revenue opportunity tool module. The lost revenue report may be communicated from the service provider computer to the healthcare provider computer.

System Overview

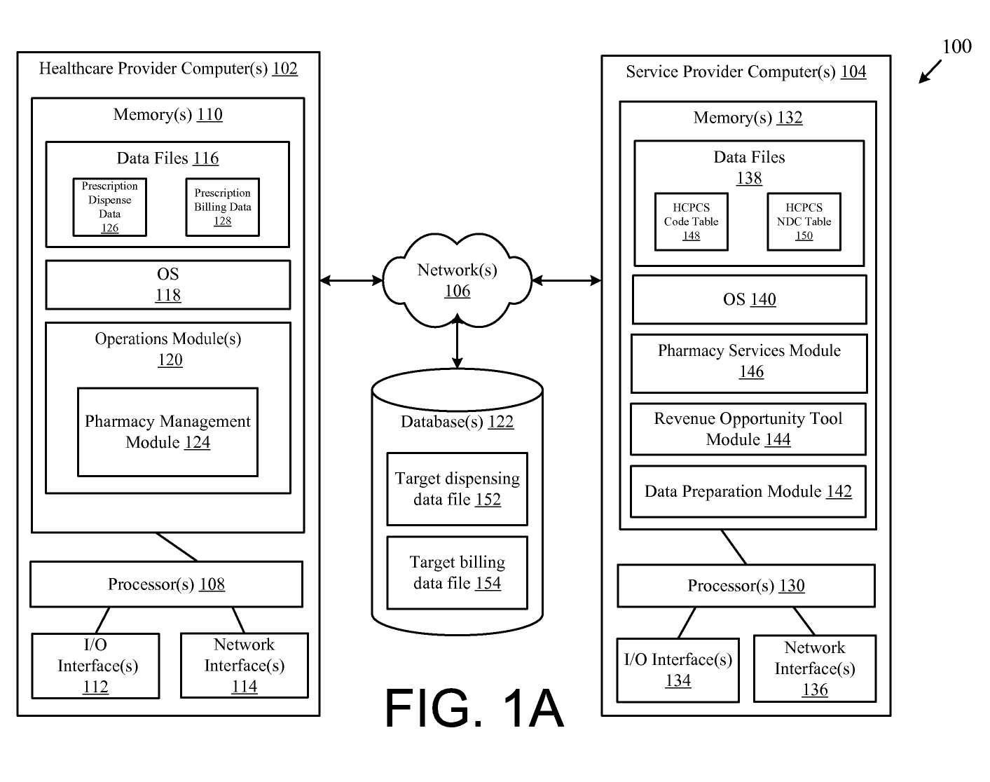

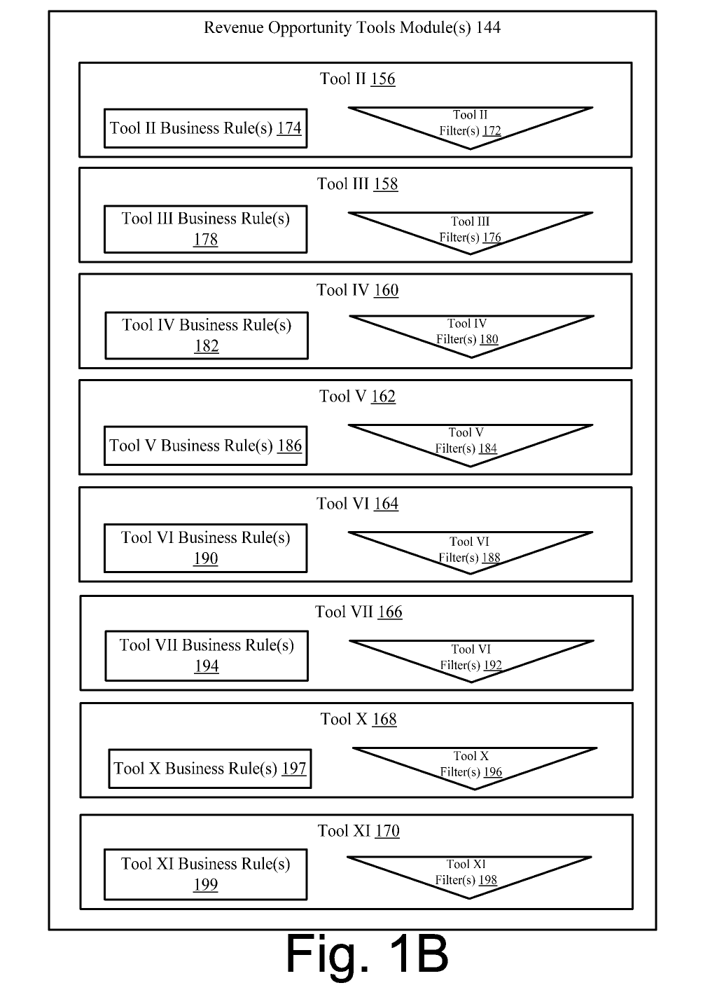

FIGS. 1A and 1B illustrate an example system 100 for facilitating, among other things, determining and communicating a lost revenue opportunity corresponding to an outpatient pharmacy transaction. As shown in FIGS. 1A and 1B, the example system 100 may include one or more healthcare provider computers 102 and/or service provider computers 104. As desired, each of the healthcare provider computers 102 and/or service provider computers 104 may include one or more processing devices that may be configured for accessing and reading associated computer-readable media having stored data thereon and/or computer-executable instructions for implementing various embodiments of the disclosure.

Generally, network devices and systems, including one or more healthcare provider computers 102 and/or service provider computers 104, may include or otherwise be associated with suitable hardware and/or software for transmitting and receiving data and/or computer-executable instructions over one or more communication links or networks. These network devices and systems may also include any number of processors for processing data and executing computer-executable instructions, as well as other internal and peripheral components currently known in the art or which may be developed in the future. Further, these network devices and systems may include or be in communication with any number of suitable memory devices operable to store data and/or computer-executable instructions. By executing computer-executable instructions, each of the network devices may form a special-purpose computer or particular machine. As used herein, the term “computer-readable medium” describes any medium for storing computer-executable instructions.

As shown in FIGS. 1A and 1B, the one or more healthcare provider computers 102 and/or service provider computers 104 may be in communication with each other via one or more networks, such as network 106, which may include one or more independent and/or shared private and/or public networks including the Internet or a publicly switched telephone network. In other example embodiments, one or more components of the system 100 may communicate via direct connections and/or communication links. Each of these components—the healthcare provider computer 102, service provider computer 104, and the network 106—will now be discussed in further detail. Although the components are generally discussed as singular components, as may be implemented in various example embodiments, in alternative exemplary embodiments each component may include any number of suitable computers and/or other components.

With continued reference to FIGS. 1A and 1B, the one or more healthcare provider computers 102 may be associated with (e.g., located within or providing computing services for) one or more hospitals and/or medical centers, urgent care facilities, home health care facilities, nursing home facilities, or the like, authorized to prescribe and/or dispense medications and/or products. The healthcare provider computer 102 may communicate healthcare transaction information for medications and/or products dispensed and billed by the healthcare provider computer 102 to the service provider computer 104. For example, the healthcare provider computer 102 may include outpatient pharmacy information such as, for example, dispensing data and billing data. The dispensing data and billing data may include, without limitation, information corresponding to one or more outpatient pharmacy transactions (e.g., a predetermination of benefits transaction, healthcare claim transaction, prescription claim or billing request, healthcare order transaction, or e-prescription transaction (i.e., electronic prescription order transaction, e-script, or e-prescription). A healthcare provider computer 102 may be any suitable processor-driven device that facilitates the processing of the communicated information to create, store, and maintain any data associated with the communication. The healthcare provider computer 102 may be a computing device that includes any number of server computers, mainframe computers, networked computers, desktop computers, personal computers, mobile devices, smartphones, digital assistants, personal digital assistants, tablet devices, Internet appliances, application-specific integrated circuits, microcontrollers, minicomputers, and/or any other processor-based devices. In certain example embodiments, the operations and/or control of the healthcare provider computer 102 may be distributed among several processing components. For example, the functionality associated with the healthcare provider computer 102 may be performed by one or more modules of the service provider computer 104.

In addition to including one or more processors 108, the healthcare provider computer 102 may further include one or more memory devices (or memory) 110, one or more input/output (“I/O”) interfaces 112, and one or more network interfaces 114. The memory devices 110 may be any suitable memory devices, for example, caches, read-only memory devices, random access memory devices, magnetic storage devices, removable storage devices, etc. The memory devices 110 may store data, executable instructions, and/or various program modules utilized by the healthcare provider computer 102, for example, data files 116, an operating system (“OS”) 118, and a healthcare provider operations module 120 to facilitate management of data files 116 and other data stored in the memory device 110 and/or one or more databases 122. The OS 118 may be any suitable software module that controls the general operation of the healthcare provider computer 102. The OS 118 may be any operating system known in the art or which may be developed in the future including, but not limited to, Microsoft Windows®, Apple OSX™, Apple iOS™ Google Android™, Linux, Unix, or a mainframe operating system.

The healthcare provider operations module 120 may include an outpatient pharmacy management module 124. The outpatient pharmacy management module 124 may include, without limitation, any number of suitable software modules and/or application programs configured to access one or more service provider computers hosting a pharmacy services module or application program via the network 106. Alternatively, the pharmacy management module 124 may communicate with the service provider computer 104 via the operations module 120. In one example, the pharmacy management module 124 may provide access to prescription dispensing data 126, prescription billing data 128, and/or other information stored in the data files 116 and/or the database 122. In one example, the prescription dispensing data 126 and the prescription billing data 128 may be from or otherwise associated with a healthcare transaction such as a healthcare claim transaction, prescription claim or billing request, healthcare order transaction, or e-prescription transaction (i.e., electronic prescription order transaction, e-script, or e-prescription). The healthcare transaction may include, without limitation, medications, medication identifiers (e.g., medication name(s), National Drug Code(s) (NDC) codes, RxNorm medication identifiers), quantity of medication to be dispensed, patient identifier information (i.e., patient name, gender, date of birth, residence address). The prescription billing data 128 may also include a cost associated with the healthcare transaction and/or an amount paid by a patient and/or a payer. In one example, a payer may include, without limitation, a claims processor (i.e., Pharmacy Benefits Manager (PBM), claims payer, healthcare insurance company, Medicare, Medicaid, or other government healthcare insurance payer, Medicare Part D provider, claims clearinghouse, etc.).

The one or more I/O interfaces 112 may facilitate communication between the healthcare provider computers 102 and one or more input/output devices, for example, one or more user interface devices, such as a display, keypad, control panel, touch screen display, remote control, microphone, etc., that facilitate user interaction with the healthcare provider computers 102. For example, the one or more I/O interfaces 112 may facilitate entry of information associated with a patient by a healthcare provider employee. The one or more network interfaces 114 may facilitate connection of the healthcare provider computers 102 to one or more suitable networks, for example, the network 106 illustrated in FIG. 1A. In this regard, the healthcare provider computers 102 may receive and/or communicate information to other network components of the system 100, such as the service provider computer 104.

With continued reference to FIGS. 1A and 1B, one or more service provider computers 104 may be associated with (e.g., located within or providing computing services for) a service provider. In certain exemplary embodiments, the service provider computer 104 may be provide a revenue enhancement service that analyzes outpatient pharmacy billing data and dispensing data to determine revenue opportunities (e.g., revenue that could have been made by the healthcare provider but was not) that may be available to a healthcare provider. For example, the service provider computer 104 may utilize prescription dispensing data 126 and/or prescription billing data 128 received and/or accessed from the healthcare provider computer 102 to determine one or more lost revenue opportunities. The service provider computer 104 may include, but is not limited to, any suitable processor-driven device that is configured for receiving, processing, and/or accessing the prescription dispensing data 126 and/or prescription billing data 128 from the healthcare provider computer 102. Any number of healthcare provider computers 102 may be in communication with the service provider computer 104 as desired in various example embodiments.

The service provider computer 104 may include any number of special-purpose computers or other particular machines, application-specific integrated circuits, microcontrollers, personal computers, minicomputers, mainframe computers, servers, networked computers, and/or other processor-driven devices. In certain example embodiments, the operations of the service provider computer 104 may be controlled by computer-executed or computer-implemented instructions that are executed by one or more processors of the service provider computer 104 to form a special-purpose computer or other particular machine that is operable to facilitate the receipt, processing, and/or accessing of the prescription dispensing data 126 and/or prescription billing data 128 to identify lost revenue opportunities. The one or more processors that control the operations of the service provider computer 104 may be incorporated into the service provider computer 104 and/or may be in communication with the service provider computer 104 via one or more suitable networks. In certain example embodiments, the operations and/or control of the service provider computer 104 may be distributed among several processing components.

Similar to the healthcare provider computer 102, the service provider computer 104 may include one or more processors 130, one or more memory devices 132, one or more input/output (“I/O”) interfaces 134, and one or more network interfaces 136. The one or more memory devices 132 may be any suitable memory device, for example, caches, read-only memory devices, random access memory devices, magnetic storage devices, removable storage devices, etc. The one or more memory devices 132 may store data, executable instructions, and/or various program modules utilized by the service provider computer 104, for example, data files 138, an operating system (“OS”) 140, a data preparation module 142, a revenue opportunity tool (ROT) module 144, and a pharmacy services module 146. In one example, the pharmacy services module 146 may communicate with the healthcare provider computer 102 to access and/or receive prescription dispensing data 126 and/or prescription billing data 128. The pharmacy services module 146 may facilitate storage of the prescription dispensing data 126 and/or the prescription billing data 128 in the data files 138. Alternatively and/or additionally, the service provider computer 104 may include or otherwise be in communication with one or more suitable databases and/or data storage devices 122 and the prescription dispensed data 126 and/or the prescription billing data 128 may be stored in the database 122.

The pharmacy services module 146 may also access a Healthcare Common Procedure Coding System (HCPCS) code table 148 and a HCPCS NDC table 150 stored in the data files 138. The HCPCS code table 148 may store a current measure, description, and payment rate for the ever increasing set of Healthcare Common Procedure Codes (HCPCS codes). The HCPCS NDC table 150 may store NDC codes for each HCPCS code and their corresponding HCPCS bill unit, bill units, bill units per package, HCPCS dosage, package size, package quantity, and drug name. The HCPCS code table 148 and the HCPCS NDC table 150 may be accessed by the ROT module 144 during the calculation of one or more lost revenue opportunity calculations, such as, for example those discussed herein below.

The OS 140 may be any operating system known in the art or which may be developed in the future including, but not limited to, Microsoft Windows®, Apple OSX™ Linux, Unix, Apple iOS™, Google Android™, or a mainframe operating system. The OS 140 may be a suitable software module that controls the general operation of the service provider computer 104 and/or that facilitates the execution of other software modules.

The data preparation module 142 or data preparation application may include computer-executable instructions operable for facilitating the extraction, transformation, and loading (ETL) of the raw outpatient pharmacy billing data and the raw prescription dispensing data received and/or accessed from the healthcare provider computer 102. In one example, the data preparation module 142 may parse the prescription dispensing data 126 and the prescription billing data 128 and load the prescription dispensing data and the prescription billing data into a target dispensing data file 152 and a target billing data file 154. In one example, each of the target dispensing data file 152 and the target billing data file 154 may include one or more tables created at the time the data is extracted and loaded. As such, each file may include several tables organized according to the time period the data was received (e.g., date/year). Alternatively, one or more tables may already reside in, for example, the target dispense file 152, and the extracted data may be loaded into an already existing table. The data preparation module 142 may run one or more data preparation procedures on the one or more tables to eliminate redundancies, eliminate corporate data fields, and/or append required information.

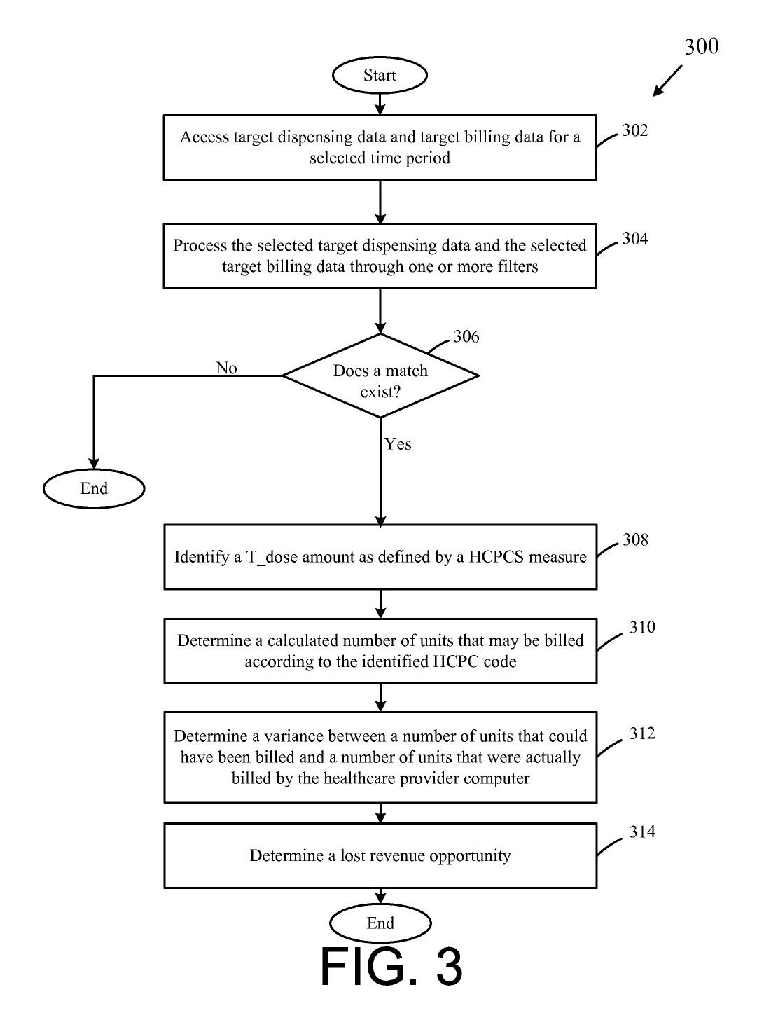

A revenue opportunity tool (ROT) module 144 or a revenue opportunity tool application may also be operative with the service provider computer 104. The ROT module 144 may include computer-executable instructions operable for determining and/or communicating a lost revenue opportunity. For example, without limitation, a lost revenue opportunity may be the result of a billing error that may have occurred during an outpatient pharmacy billing cycle. For example, a lost revenue opportunity may include, without limitation, incorrect billing information (e.g., an incorrect billing code), an incorrect quantity or additional quantity that could have been billed, (e.g., unbilled waste product (for example, a single use vial that is labeled to contain 100 units of a drug has 95 units administered to a patient and 5 units discarded (unbilled waste product))), and/or failing to bill for a dispensed medication and/or product at all. As illustrated in FIG. 1B, the ROT module 144 may include, without limitation one or more revenue opportunity tools. For example, the ROT module 144 may include at least a tool II 156, a tool III 158, a tool IV 160, a tool V 162, a tool VI 164, a tool VII 166, a tool X 168, and a tool XI 170. Each of the tools 156-170 may correspond to a form or type of lost revenue opportunity that may be identified through the application of one or more associated business rules and one or more filters. A detailed description of example methods incorporating each of the revenue opportunity tools and corresponding business rules and filters to identify lost revenue opportunities will be discussed hereinafter in FIGS. 3-10.

In certain example embodiments, the service provider computer 104 may also be operable to generate one or more invoices or reports for the communication of lost revenue opportunity. A wide variety of different types of invoices or reports may be generated as desired in various example embodiments of the disclosure. Invoices or reports may be sorted or formatted utilizing a wide variety of different criteria, parameters, and/or techniques. Additionally, the service provider computer 104 may communicate or direct the communication of generated invoices or reports to the healthcare provider computer 102 and/or a healthcare provider back-office computer for the corporate offices of a hospital or other entity.

A wide variety of different techniques and/or software programs may be utilized to format a generated invoice and/or report. For example, an invoice or report may be formatted as a comma-separated-value (CSV) file, as a spreadsheet file, as a word processor file, as a text file, etc. Additionally, a wide variety of different communication techniques may be utilized to communicate a report to the recipient, including but not limited to, electronic transaction requests, email, short message service (SMS) messaging, multimedia message service (MMS) messaging, other electronic communications, paper mail, etc. An invoice report may be pushed to a recipient (e.g., the healthcare provider computer or healthcare provider back-office computer) by the service provider computer 104, or alternatively pulled from the service provider computer 104 by the recipient submitting a request for one or more invoices or reports. Additionally, in certain embodiments, a report may be made available for download from an appropriate website or server, such as a website hosted by the service provider computer 104.

The service provider computer 104 may include additional program modules for performing other processing methods described herein. Those of ordinary skill in the art will appreciate that the service provider computer 104 may include alternate and/or additional components, hardware, or software without departing from the scope of the disclosure.

With continued reference to the service provider computer 104, the one or more I/O interfaces 134 may facilitate communication between the service provider computer 104 and one or more input/output devices, for example, one or more user interface devices, such as a display, keypad, control panel, touch screen display, remote control, microphone, etc., that facilitate user interaction with the service provider computer 104. The one or more network interfaces 136 may facilitate connection of the service provider computer 104 to one or more suitable networks, for example, the network 106 illustrated in FIG. 1A. In this regard, the service provider computer 104 may communicate with other components of the system 100, such as the healthcare provider computer 102 and the database 122.

The network 106 may include any telecommunications and/or data network, whether public, private, or a combination thereof, including a local area network, a wide area network, an intranet, the Internet, intermediate handheld data transfer devices, and/or any combination thereof and may be wired and/or wireless, or any combination thereof. The network 106 may also allow for real time, offline, and/or batch transactions to be transmitted between or among the healthcare provider computer 102, the service provider computer 104, and the database 122. Various methodologies as described herein, may be practiced in the context of distributed computing environments. Although the service provider computer 104 is shown for simplicity as being in communication with the healthcare provider computer 102 or the database 122 via one intervening network 106, it is to be understood that any other network configurations are possible. For example, intervening network 106 may include a plurality of networks, each with devices such as gateways and routers for providing connectivity between or among the components of the system 100. Instead of or in addition to the network 106, dedicated communication links may be used to connect various devices in accordance with an example embodiment. For example, the service provider computer 104 may form the basis of network 110 that interconnects the healthcare provider computer 102 and the database 122.

Those of ordinary skill in the art will appreciate that the system 100 shown in and described with respect to FIGS. 1A and 1B is provided by way of example only. Numerous other operating environments, system architectures, and device and network configurations are possible. Other system embodiments can include fewer or greater numbers of components and may incorporate some or all of the functionality described with respect to the system components shown in FIG. 1. For example, in an exemplary embodiment, the service provider computer 104 (or a separate and distinct computer system) may be implemented as a specialized processing machine that includes hardware and/or software for performing the methods described herein. Accordingly, embodiments of the disclosure should not be construed as being limited to any particular operating environment, system architecture, or device or network configuration.

Operational Overview

Certain portions of the exemplary methods below will be described with reference to determining and communicating lost revenue opportunities corresponding to an outpatient pharmacy transaction. While the methods described below are described with reference to an outpatient pharmacy transaction, each form of a healthcare transaction, such as a predetermination of benefits transaction, healthcare claim transaction, prescription claim or billing request, healthcare order transaction, or e-prescription transaction (i.e., electronic prescription order transaction, e-script, or e-prescription), should be individually read as being used in the methods described below.

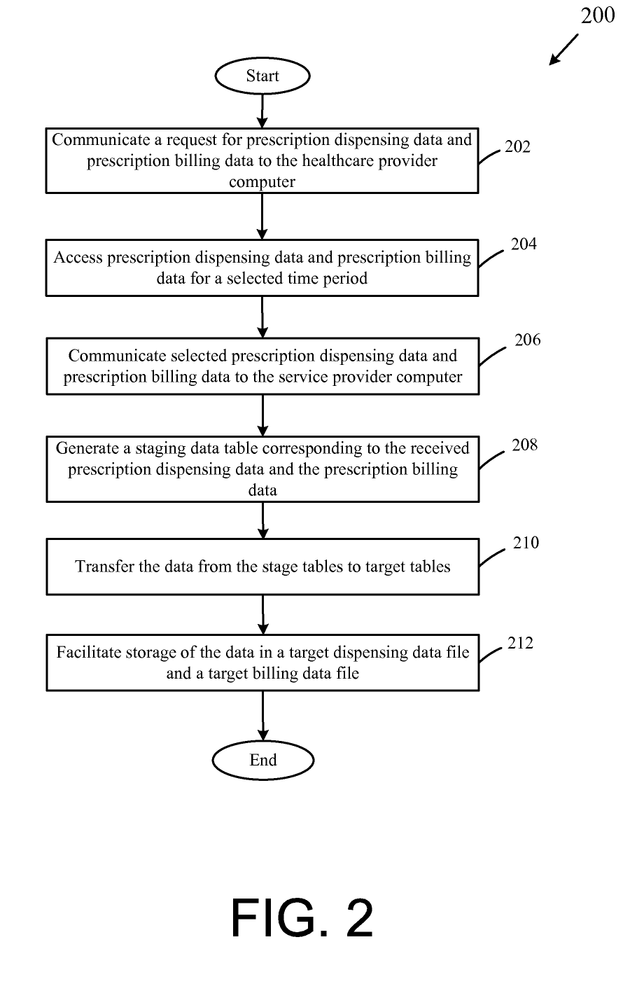

FIG. 2 is a flow chart illustrating an example method 200 for creating and/or storing a target prescription data table and/or a target billing data table with prescription dispensing data and/or prescription billing data for/from an outpatient pharmacy transaction, according to an example embodiment of the disclosure. Referring now to FIGS. 1A and 2, the exemplary method 200 begins at the START step and continues to step 202, where a service provider computer, such as service provider computer 104, may communicate a request to the healthcare provider computer 102. In one example, the service provider computer 104 may engage the pharmacy services module 146 to communicate the request to the healthcare provider computer 102. The request may be communicated to the healthcare provider computer on a regularly scheduled interval (e.g., daily, weekly, biweekly, monthly, bimonthly, quarterly, semi-annually, annually, etc.). Alternatively, the service provider computer 104 may communicate the request to the healthcare provider computer 102 anytime or at any duration. While the request is described as being communicated from the service provider computer 104 to the healthcare provider computer 102, it is to be appreciated that the healthcare provider computer 102 may initiate communication.

In one example, the communication may include a request for prescription dispensing data, such as prescription dispensing data 126 and prescription billing data, such as prescription billing data 128. In one example, the prescription dispensing data 126 and the prescription billing data 128 may include data extracted from one or more outpatient pharmacy transactions for a healthcare provider pharmacy (e.g., a hospital pharmacy, clinic pharmacy, etc.). The outpatient pharmacy transactions may include patient identification information (e.g., medical record numbers (MRNs)), medications and/or products prescribed, medications and/or products filled, quantity filled, an amount associated with the amount billed to either or both the patient and/or a payer for the transaction, and/or the like. For example, the outpatient pharmacy transaction may be in accordance with a version of the NCPDP Telecommunication Standard, although other standards may be utilized as well. As an example, the outpatient pharmacy transaction may include one or more the following information:

Payer ID/Routing Information
Transaction Payer Identifier(s) that designates a destination of the healthcare transaction 210 (e.g., Banking Identification Number (BIN) Number, BIN Number and Processor Control Number (PCN), or BIN Number and Group ID)

Patient Identification Information
Name (e.g. Patient Last Name, Patient First Name, etc.)
Date of Birth of Patient
Age of Patient
Patient Gender Code
Patient Address (e.g. Street Address, City, State/Province, Zip/Postal Code, etc.)
Patient Contact Information (e.g. patient telephone number, email address, etc.)
Patient ID or other identifier (e.g., Health Insurance Claim Number (HICN), social security number, etc.)

Insurance/Coverage Information
Cardholder Name (e.g. Cardholder First Name, Cardholder Last Name)
Cardholder ID and/or other identifier (e.g. person code)
Group ID and/or Group Information
State payer information

Provider Information
Prescriber Information
Primary Care Provider ID or other identifier (e.g., National Provider Identifier (NPI) code)
Primary Care Provider Name (e.g. Last Name, First Name)
Prescriber ID or other identifier (e.g. NPI code, Drug Enforcement

Administration (DEA) number)
Prescriber Name (e.g. Last Name, First Name)
Prescriber Contact Information (e.g. Telephone Number)
Pharmacy or other Healthcare Provider Information (e.g. store name, chain identifier, etc.)
Pharmacy or other Healthcare Provider ID (e.g. NPI code)

Claim Information
Drug, service, or product information (e.g. via NDC code, RxNorm code, and/or medication name)
Prescription/Service Reference Number
Date Prescription Written
Quantity Dispensed
Days' Supply
Diagnosis/Condition
Pricing information for the drug/service/product (e.g. network price, Usual & Customary price)
Number of Refills Authorized
One or more Drug Utilization (DUR) Codes
Dispense as Written (DAW)/Product Selection Code

Date of Service (e.g., Date Transaction was Completed)

At step 204, the healthcare provider computer 102 may access the prescription dispensing data and/or the prescription billing data for the selected time period. This may encompass prescription dispensing data and/or prescription billing data from a very large volume of outpatient pharmacy transactions. In one example, the pharmacy management module 124 may access the prescription dispensing data file 126 and the prescription billing data file 128 stored in data files 116 and select the data corresponding to the selected time period (e.g., first quarter, Jan. 1, 2014-Mar. 31, 2014, etc.). At step 206, the healthcare provider computer 102 may communicate the prescription dispensing data and the prescription billing data for the selected time period to the service provider computer 104. In one example, the healthcare provider computer 102 may engage the pharmacy management module 124 to communicate the accessed prescription dispensed data and the prescription billing data to the pharmacy services module 146 of the service provider computer 104 via, for example, the network 106.

At step 208, the service provider computer 104 may generate one or more staging data tables corresponding to the received prescription dispensing data and/or the prescription billing data. In one example, the service provider computer 104 may engage the data preparation module 142 to parse the received prescription dispensing data and/or the prescription billing data. The parsed data may be placed into one or more stage dispensing data tables and/or one or more stage billing data tables. For example, the data preparation module 142 may call a data preparation procedure (e.g., RAAM_Stage_Partners.dbo.usp_EDI_InsertRecordToStage) to parse the received prescription billing data. The parsed data may be inserted as one record in a corresponding stage table. As an example, the data inserted into a staged billing table may include:

TransactionSetControlNumber,

ClaimFormat,

FilePath,

ClaimID,

AdmissionDate,_{—}

MEDICALRECORDNUMBER,

iUNITS,_{—}

iRevCode,

iAMT,

iDOS,

iPROC,

IMODA,

ClaimAmount,_{—}

FACILITYCODEVALUE,

PRIMARYPAYERNAME,

PRIMARYPAYERID,

OtherPRIMARYPAYERNAME,

OtherPRIMARYPAYERID,

BillingProviderName,

BillingProviderID,

ServiceLineNo,

ServiceFacilityName,

ServiceFacilityID,

StatementDates,

NTE_CLAIM_INFORMATION,

FileName,

BHT_HierarchicalStructureCode,

BHT_TransactionSetPurposeCode,

BHT_ReferenceIdentification,

BHT_Date,

BHT_Time,

BHT_TransactionTypeCode,

SBR_OtherPayerSeqNoCode,

SBR_PayerSeqNoCode,

REF_RepricedClaim_RefenceNo,

REF_Adjusted_Repriced_RefenceNo,

FileCheckSum

At step 210, the service provider computer 104 may transfer the contents of the stage table to a target table. In one example, the service provider computer 104 may engage the data preparation module 142 to run one or more data preparation procedures to move the data in the prescription dispense stage table and the prescription billing stage table to a corresponding prescription dispense target table and a prescription billing target table. For example, after the entire contents of a file are all loaded to the stage table, a stored procedure (e.g., RAAM_Stage_Partners.dbo.usp_EDI_MoveStageToPerm) may be called to move the data to a target table. In one example, a prescription dispense target table is presented for reference in Table 1.

TABLE 1

| Target Table Column | DATA FIELD | DESCRIPTION |
|---|---|---|
| PatientNumber | Dispensed Patient | MRN |
| | ID | |
| AccountNumber | Dispensed Patient | Financial Account |
| | Account Number or | Number or Billing |
| | Encounter Number | Number or Encounter |
| | | number |
| DispensedLocation | Dispensed Location | Hospital/clinic ID from |
| | ID | raw dispensed data file |
| Facility | Dispensed Location | Hospital/clinic name |
| | Name | from raw dispensed data |
| | | file |
| SiteId | Dispensed Site ID | Hospital system name |
| DispensedLocationType | Dispensed Location | Clinic or pharmacy |
| | Type | |
| DateDispensed | Dispensed Date | Date/Time drug was |
| | | dispensed to patient |
| Disp_NDC | Dispensed NDC | This may be missing or |
| | | inaccurate |
| Disp_DrugDescription | Dispensed Drug | Drug name/description of |
| | description | what was dispensed from |
| | | raw dispensed data file |
| Disp_Qty_Amount | Dispensed QTY | TOTAL Quantity of drug |
| | Amount | UNITS dispensed per 1 |
| | | dispensing transaction |
| Disp_DoseAmt | Dispensed Dose | What total dose amount |
| | Amount | is equal to (e.g. 1000, |
| | | 500 etc.) per 1 |
| | | dispensing transaction |
| Disp_DoseUnit | Dispensed Dose | Unit of measurement |
| | unit of measure | (e.g. ML, MG etc.) |
| Total_Charge | Dispensed Total | Total patient charge |
| | Charge Amount ($) | billed for 1 dispensing |
| | | transaction |
| DispensedGenericName | Dispensed | May or may not be |
| | GenericName | available |
| Dispensed BrandName | Dispensed | May or may not be |
| | BrandName | available |
| Disp_JCode | Dispensed J-CODE | May or may not be |
| | | available |
| | Dispensed J-CODE | May or may not be |
| | description | available |
| FacilityChargeCode | Dispensed PIM | Code that represents |
| | Charge Code | the drug in the |
| | | pharmacy PIM |
| FilePath | N/A | Path of the file that |
| | | the data came from. |
| Disp_DoseForm | N/A | |
| Disp_DispensedUnits | Charge_Amount | Dispensed Units |
| Disp_ChargeSource | Charge_Source | Indicates whether charge |
| | | is automatic or manual |
| | | process |
| PatientType | Patient Type | Inpatient or Outpatient |

At step 212, the service provider computer 104 may store the one or more target dispensing data tables and the one or more billing data tables in the target dispensing data file 152 and the target billing data file 154. The method may end after step 212.

FIG. 3 is a flow chart illustrating an example method 300 for determining lost revenue for a medication and/or product that was dispensed to a patient but incorrectly billed as a part of an outpatient pharmacy transaction, according to an example embodiment of the disclosure. Referring now to FIGS. 1A, 1B, and 3, the exemplary method 300 begins at the START step and continues to step 302, where a service provider computer, such as service provider computer 104, may access target dispensing data and target billing data for a selected time period (e.g., first quarter, second quarter, January, June, 2012, etc.) in the target prescription data file 152 and the target billing data file 154. In one example, the service provider computer 104 accesses the target dispensing data and target billing data that was stored in the target dispensing data tables and target billing data tables in step 212 of FIG. 2.

At step 304, the service provider computer 104 may process the target dispensing data and the target billing data through one or more filters. In one example, the service provider computer 104 may employ a tool II 156 of the ROT module 144. The tool II 156 may engage one or more tool II filters 172 to filter the target dispensing data and the target billing data to remove one or more dispense records and one or more billing records that may not be used by the tool II 156 during a determination of a lost revenue opportunity. The one or more tool II filters 172 may include, without limitation, a payer filter to identify one or more particular payers (e.g., via BIN Number, BIN Number and PCN or BIN Number and Group ID), a drug filter to identify one or more particular medications (e.g., via NDC code or RxNorm number), and/or a patient type filter to identify a patient as either an inpatient type or an outpatient type. The payer filter may, for example, identify those payers that utilize a fee schedule. In one example, a fee schedule may outline what a provider (i.e., a physician, hospital, urgent care facility, etc.) charges for various medications and/or products. The drug filter may identify medications and/or products that are a target drug. A target drug may include medications and/or products that have a payment rate (i.e., a an amount of money paid per unit associated with an HCPCS code) greater than $0.00 and may vary by payer. The patient type filter may also identify whether the patient, at the time of service, was categorized as an outpatient. For example, the patient type filter may parse the target dispensing data to identify a patient type (i.e., inpatient or outpatient) associated with a pharmacy transaction. Data identified in the target dispensing data and the target billing data as satisfying, at least, each of the tool II filters 172, will be further processed in step 306 in one example embodiment.

Processing of the filtered data identified in step 304 may further include an application of one or more business rules, for example, one or more tool II business rules 178. It is to be appreciated that the one or more tool II business rules 178 may be applied sequentially or concurrently during processing. However, for discussion purposes, the business rules will be described as being applied to the identified data sequentially.

At step 306, a business rule can be applied to the filtered data identified in step 304 to determine whether a match exists between a dispense event and a bill event for a selected time period (e.g., a day, a week, a month, first quarter, second quarter, January, June, 2012, etc.). For example, the tool II 156 may parse the filtered target dispensing data and the filtered target billing data to determine whether a match exists between a dispense event and a bill event. The match may, for example, be based at least in part upon a patient identifier (e.g., an MRN), such that an MRN identified in the prescription dispense target event is also identified in the prescription billing target event. If a match is not identified, the NO branch is followed and processing may end. If a match is identified, the YES branch is followed and processing may proceed to step 308. If a match does not exist, the NO branch is followed and the process may end.

At step 308, processing may continue with application of a business rule to determine a medication and/or product dose that may be administered to a patient (“T_dose amount”) as defined by a HCPCS measure. In one example, the tool II 156 may identify a HCPCS code for a matching set of target dispensing data and target billing data. The tool II 156 may compare the identified HCPCS code to the HCPCS code table 148 to determine a T_dose amount corresponding to the HCPCS code. For example, the tool II 156 may parse the HCPCS code table 148 to identify a HCPCS measure associated with the identified HCPCS code. For example, the HCPCS code table 148 may indicate that for HCPCS 1-J0640, 50 mg is the HCPCS measure.

At step 310, a business rule may be applied to determine a calculated number of units that may be billed according to the identified HCPCS code (“CalcUnits”). In one example, the tool II 156 may compare the identified HCPCS code to the HCPCS NDC table 150 to identify a billing unit corresponding to the HCPCS code. For example, the tool II 156 may parse the HCPCS NDC table 150 to identify a HCPCS bill unit corresponding to the identified HCPCS code. To determine a number of units that may be billed (“CalcUnits”), the tool II 156 may calculate the T_dose amount divided by the identified HCPCS bill unit. For example, if the T_dose amount is 1000 mg and the bill unit is 50, then the CalcUnits=1000 mg/50 mg. At step 312, a business rule may be applied to determine a variance for the number of units actually billed by the provider (i.e. the “iUnits” listed in the target billing data) and the CalcUnits. In one example, the tool II 156 may parse the target billing data table to identify a value corresponding to the iUnits. The variance may then be calculated by subtracting the number of units that were actually billed by the provider, the iUnits, from the number of units that may be billed, the CalcUnits.

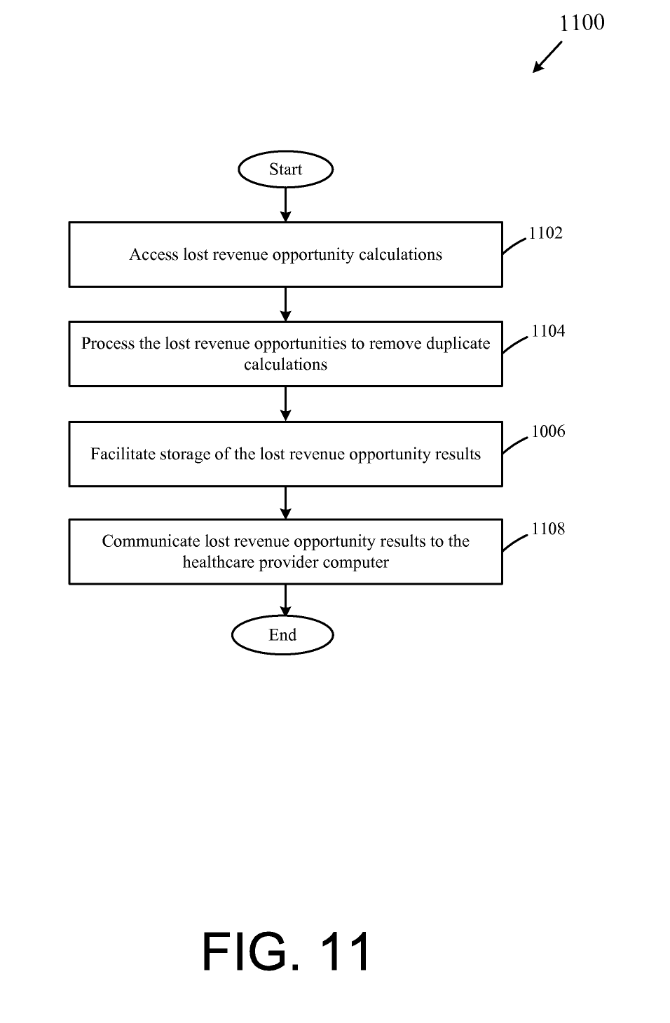

At step 314, the processing may continue by calculating a lost revenue opportunity. In one example, the lost revenue opportunity may be determined based upon the variance for number of units actually billed calculated in step 312 multiplied by a payment rate. In one example, the payment rate may be identified in the fee schedule. The calculated lost revenue opportunity may be reported to the healthcare provider computer 102, as described in FIG. 11. However, if the calculated lost revenue opportunity is less than a set dollar amount (i.e., $5, $10, $25, or any suitable amount), then, the potential revenue opportunity may be excluded and not reported to the healthcare provider computer 102. While method 300 is described using certain filters and/or business rules, it is to be appreciated that some filters and/or business rules may be removed and/or added to enhance the lost revenue opportunity results. The method 300 may end after step 314.

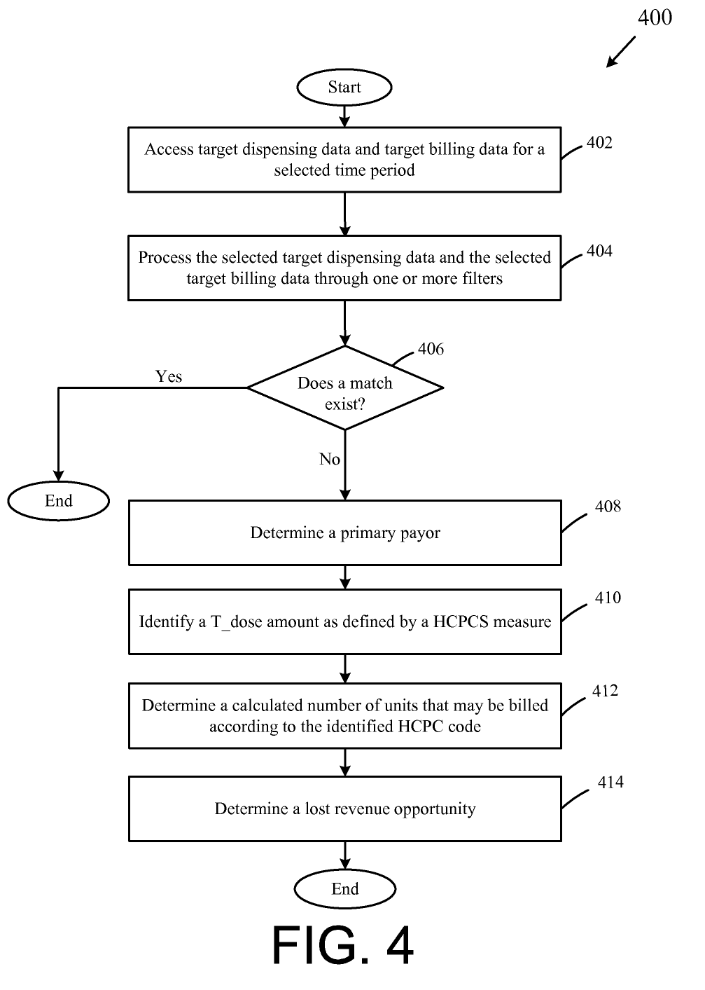

FIG. 4 is a flow chart illustrating an example method 400 for determining lost revenue for a medication and/or product as a part of an outpatient pharmacy transaction, according to an example embodiment of the disclosure. Referring now to FIGS. 1A, 1B, and 4, the exemplary method 400 begins at the START step and continues to step 402, where a service provider computer, such as service provider computer 104, may access target dispensing data and target billing data for a selected time period (e.g., a day, a week, a month, two months, first quarter, second quarter, January, June, 2012, etc.) in the target prescription data file 152 and the target billing data file 154. In one example, the service provider computer 104 accesses the target dispensing data and target billing data that was stored in the target dispensing data tables and target billing data tables in step 212 of FIG. 2.

At step 404, the service provider computer 104 may process the target dispensing data and the target billing data through one or more filters. In one example, the service provider computer 104 may employ a tool III 158 of the ROT module 144. The tool III 158 may engage one or more tool III filters 176 to filter the target dispensing data and the target billing data to remove one or more dispense records and one or more billing records that may not be used by the tool III 158 during a determination of a lost revenue opportunity. The one or more tool III filters 176 may include, without limitation, a drug filter to identify one or more particular medications (e.g., via NDC code or RxNorm number) a patient type filter to identify a patient as either an inpatient type or an outpatient type, a payer filter to identify one or more particular payers (e.g., via BIN Number, BIN Number and PCN or BIN Number and Group ID), and/or an paper claims filter to exclude paper claims. The drug filter may identify medications and/or products that are a target drug. A target drug, as described herein, may include medications and/or products that have a payment rate greater than $0.00 and may vary by payer. The patient type filter may also identify whether the patient, at the time of service, was categorized as an outpatient. For example, the patient type filter may parse the target dispensing data and/or the target billing data to identify a patient type (i.e., inpatient or outpatient. The payer filter may identify those payer(s) that are non-Medicaid payer(s). The filter corresponding to excluding paper claims may exclude dispense records that represent paper claims. In one example, a prescription dispense transaction record designated as a ‘paper claim’ would not have a corresponding billing record and would therefore not be utilized by the tool III 158 to determine a lost revenue opportunity. The paper claims may have been flagged as such during the data loading process described in FIG. 2 to prevent the data from being included in any future lost revenue opportunity calculations. Data identified in the target dispensing data and the target billing data as satisfying, at least, each of the tool III filters 176, can be further processed in step 406. Processing of the data identified in step 404 may further include an application of one or more business rules, for example, one or more tool III business rules 178. It is to be appreciated that the one or more tool III business rules 178 may be applied sequentially or concurrently during processing. However, for discussion purposes, the business rules will be described as being applied to the identified data sequentially.

At step 406, a business rule can be applied to the filtered data identified in step 404 to determine whether a match exists between a dispense event and a bill event for a selected time period (e.g., a day, a week, a month, two months, first quarter, second quarter, January, June, 2012, etc.). For example, the tool III 158 may parse the filtered target dispensing data and the filtered target billing data to determine whether a match exists between a dispense event and a bill event. The match may, for example, be based at least in part upon a patient identifier (e.g., an MRN and date of service (IDOS)), such that an MRN and IDOS identified in the prescription dispense target event is also identified in the prescription billing target event. If a match is not identified, the NO branch is followed to step 408. If a match does exist, the YES branch is followed and the process may end.

At step 408, processing may continue with application of a business rule to the data identified in step 408 to determine a primary payer for a selected time period. In one example, the tool III 158 may parse the prescription billing target events to identify a payer that corresponds to the prescription billing target event closest to the date of the prescription dispense target event. For example, if the prescription billing target events for the selected time period include 5 transactions corresponding to Medicare as the payer and 3 transactions corresponding to a specific private insurance carrier as the payer, the primary payer may be determined to be Medicare for the selected time period if the Medicare transaction occurred closest to the prescription dispense target event date. Alternatively and/or additionally, a primary payer may be determined from prescription dispense target events based upon information received from the Healthcare Provider Computer (102). If a primary payer cannot be identified from either the prescription billing target events or the prescription dispense target events, the lost revenue opportunity is assumed to be zero and the method may end.

At step 410, processing may continue with application of a business rule to determine a medication and/or product dose that may be administered to a patient (“T_dose amount”) as defined by a HCPCS measure. In one example, the tool III 158 may identify a HCPCS code for a matching set of target dispensing data and target billing data. The tool III 158 may compare the identified HCPCS code to the HCPCS code table 148 to determine a T_dose amount corresponding to the HCPCS code. For example, the tool III 158 may parse the HCPCS code table 148 to identify a HCPCS measure associated with the identified HCPCS code.

At step 412, a business rule may be applied to determine a calculated number of units that may be billed according to the identified HCPCS code (“CalcUnits”). In one example, the tool III 158 may compare the identified HCPCS code to the HCPCS NDC table 150 to identify a billing unit corresponding to the HCPCS code. For example, the tool III 158 may parse the HCPCS NDC table 150 to identify a HCPCS bill unit corresponding to the identified HCPCS code. To determine a number of units that may be billed (“CalcUnits”), the tool III 158 may calculate the T_dose amount divided by the identified HCPCS bill unit. At step 414, the processing may continue by calculating a lost revenue opportunity. In one example, the lost revenue opportunity may be determined based upon the CalcUnits calculated in step 410 multiplied by a payment rate associated with the primary payer. The calculated lost revenue opportunity may be reported to the healthcare provider computer 102, as describe in FIG. 11. However, if the calculated lost revenue opportunity is less than a set dollar amount (i.e., $5, $10, $25, or any desired amount), then the potential revenue opportunity may be excluded and not reported to the healthcare provider computer 102. While method 400 is described using certain filters and/or business rules, it is to be appreciated that some filters and/or business rules may be removed and/or added to enhance the lost revenue opportunity results. The method 400 may end after step 414.

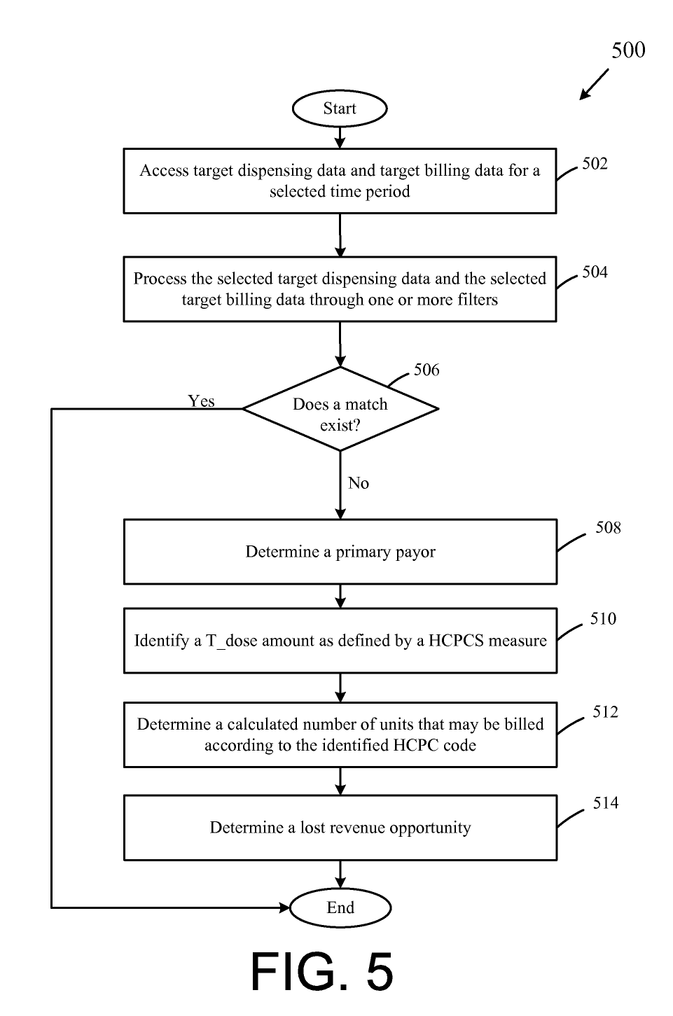

FIG. 5 is a flow chart illustrating an example method 500 for determining lost revenue for a medication and/or product that was dispensed but was not billed as a part of an outpatient pharmacy transaction, according to an example embodiment of the disclosure. Referring now to FIGS. 1A, 1B, and 5, the exemplary method 500 begins at the START step and continues to step 502, where a service provider computer, such as service provider computer 104, may access target dispensing data and target billing data for a selected time period (e.g., a day, a week, a month, two months, first quarter, second quarter, January, June, 2012, or any other desired period) in the target prescription data file 152 and the target billing data file 154. In one example, the service provider computer 104 accesses the target dispensing data and target billing data that was stored in the target dispensing data tables and target billing data tables in step 212 of FIG. 2.

At step 504, the service provider computer 104 may process the target dispensing data and the target billing data through one or more filters. In one example, the service provider computer 104 may employ a tool IV 160 of the ROT module 144. The tool IV 160 may engage one or more tool IV filters 180 to filter the target dispensing data and the target billing data to remove one or more dispense records and one or more billing records that may not be used by the tool IV 160 during a determination of a lost revenue opportunity. The one or more tool IV filters 180 may include, without limitation, a drug filter to identify one or more particular medications (e.g., via NDC code or RxNorm number), a patient type filter to identify a patient as either an inpatient type or an outpatient type, a payer filter to identify one or more particular payers (e.g., via BIN Number, BIN Number and PCN or BIN Number and Group ID), and/or a paper claims filter to exclude paper claims. The drug filter may identify medications and/or products that are a target drug. The patient type filter may also identify whether the patient, at the time of service, was categorized as an outpatient. For example, the patient type filter may parse the target dispensing data and/or the target billing data to identify a patient type (i.e., inpatient or outpatient). The payer filter may identify those payers that are non-Medicaid payers. The filter corresponding to excluding paper claims may exclude dispense records that represent paper claims. Data identified in the target dispensing data and the target billing data as satisfying, at least, each of the tool IV filters 180, can be further processed in step 506 in certain example embodiments.

Processing of the data identified in step 504 may further include an application of one or more business rules, for example, one or more tool IV business rules 182. It is to be appreciated that the one or more tool IV business rules 182 may be applied sequentially or concurrently during processing. However, for discussion purposes, the business rules will be described as being applied to the identified data sequentially.

At step 506, processing may continue with application of a business rule to the filtered data identified in step 504 to determine whether a match exists between a dispense event and a bill event for a selected time period (e.g., a day, a week, a month, two months, first quarter, second quarter, January, June, 2012, or any other desired time period). For example, the tool IV 160 may parse the filtered target dispensing data and the filtered target billing data to determine whether a match exists between a dispense event and a bill event. The match may, for example, be based at least in part upon a patient identifier (e.g., an MRN), such that an MRN identified in the prescription dispense target event is also identified in the prescription billing target event. If a match is not identified, the NO branch is followed to step 508. If a match exists, the YES branch is followed and processing may end.

At step 508, one or more business rules can be applied to the data identified in step 506 to determine a primary payer for a selected time period. In one example, the tool IV 160 may parse the prescription billing target events to identify a payer that corresponds to the greatest number of prescription billing target events. For example, if the prescription billing target events for the selected time period include 5 transactions corresponding to Medicare as the payer and 3 transactions corresponding to a specific private insurance carrier as the payer, the primary payer may be determined to be Medicare for the selected time period. Alternatively and/or additionally, a primary payer may be determined from prescription dispense target events. If a primary payer cannot be identified from either the prescription billing target events or the prescription dispense target events, the lost revenue opportunity is assumed to be zero and the method may end.

At step 510, processing may continue with application of a business rule to determine a medication and/or product dose that may be administered to the patient (“T_dose amount”) as defined by a HCPCS measure. In one example, the tool IV 160 may identify a HCPCS code for a matching set of target dispensing data and target billing data. The tool IV 160 may compare the identified HCPCS code to the HCPCS code table 148 to determine a T_dose amount corresponding to the HCPCS code. For example, the tool IV 160 may parse the HCPCS code table 148 to identify a HCPCS measure associated with the identified HCPCS code.

At step 512, one or more business rules can be applied to determine a calculated number of units that may be billed according to the identified HCPCS code (“CalcUnits”). In one example, the tool IV 160 may compare the identified HCPCS code to the HCPCS NDC table 150 to identify a billing unit corresponding to the HCPCS code. For example, the tool IV 160 may parse the HCPCS NDC table 150 to identify a HCPCS bill unit corresponding to the identified HCPCS code. To determine a number of units that may be billed (“CalcUnits”), the tool IV 160 may calculate the T_dose amount divided by the identified HCPCS bill unit.

At step 514, the lost revenue opportunity can be calculated. In one example, the lost revenue opportunity may be determined based upon the CalcUnits calculated in step 512 multiplied by a payment rate for with the primary payer. The calculated lost revenue opportunity may be reported to the healthcare provider computer 102, as describe in FIG. 11. However, if the calculated lost revenue opportunity is less than a set dollar amount (i.e., $5, $10, $25, or any suitable amount), then the potential revenue opportunity may be excluded and not reported to the healthcare provider computer 102. While method 500 is described using certain filters and/or business rules, it is to be appreciated that some filters and/or business rules may be removed and/or added to enhance the lost revenue opportunity results. The method 500 may end after step 514.

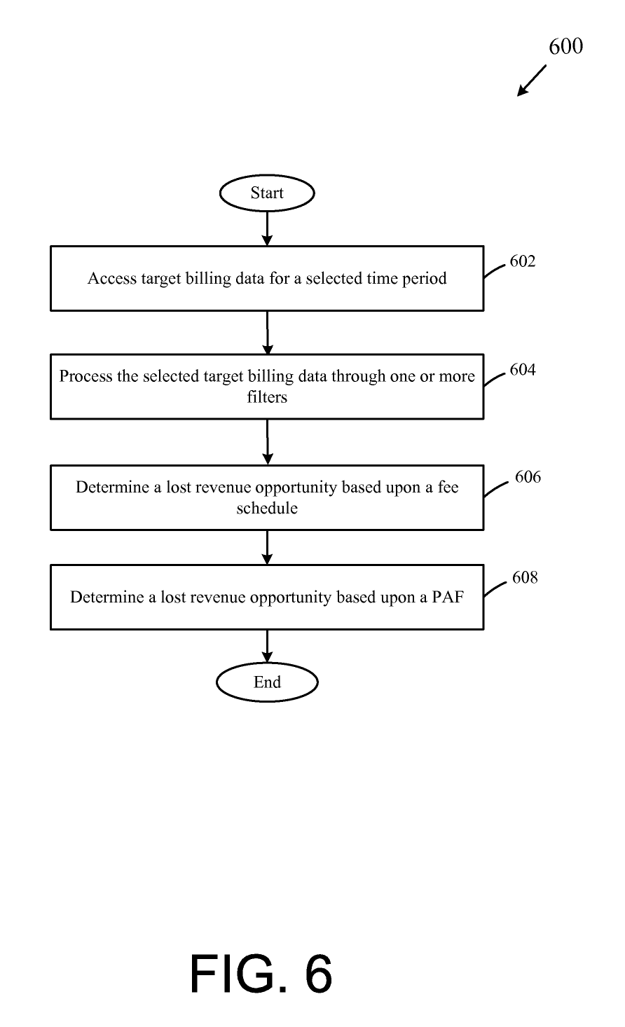

FIG. 6 is a flow chart illustrating an example method 600 for determining lost revenue for a medication and/or product that was improperly coded during a billing process as a part of an outpatient pharmacy transaction, according to an example embodiment of the disclosure. Referring now to FIGS. 1A, 1B, and 6, the exemplary method 600 begins at the START step and continues to step 602, where a service provider computer, such as service provider computer 104, may access a target billing data for a selected time period (e.g., a day, a week, a month, two months, first quarter, second quarter, January, June, 2012, or any other desired time period) in the target billing data file 154. In one example, the service provider computer 104 accesses the target billing data tables in step 212 of FIG. 2.

At step 604, the service provider computer 104 may process the target billing data through one or more filters. In one example, the service provider computer 104 may employ a tool V 162 of the ROT module 144. The tool V 162 may engage one or more tool V filters 184 to filter the target billing data to remove one or more billing records from the target billing data that may not be used by the tool V 162 during a determination of a lost revenue opportunity. The one or more tool V filters 184 may include, without limitation, a rev code filter to identify the billing code, a drug filter to identify one or more particular medications (e.g., via NDC code or RxNorm number), a patient type filter to identify a patient as either an inpatient type or an outpatient type, and/or a payer filter to identify one or more particular payers (e.g., via BIN Number, BIN Number and PCN or BIN Number and Group ID). The rev code filter may identify a billing record in the target billing data table that utilizes a billing code other than Rev636 (e.g., Rev250, Rev255, etc.). The drug filter may identify medications and/or products that are a target drug. The patient type filter may identify whether the patient, at the time of service, was categorized as an outpatient. For example, the patient type filter may parse the target billing data to identify a patient type (i.e., inpatient or outpatient). The payer filter may identify those payer(s) that are non-Medicaid or any other desired type of payer(s). Data identified in the target billing data as satisfying, at least, each of the tool V filters 184, will be further processed in step 606.

Processing of the data identified in step 604 may further include an application of one or more business rules, for example, one or more tool V business rules 186. It is to be appreciated that the one or more tool V business rules 186 may be applied sequentially or concurrently during processing. However, for discussion purposes, the business rules will be described as being applied to the identified data sequentially. At step 606, processing may continue with application of a tool V business rule 186 to the filtered data from step 604 to determine a lost revenue opportunity based upon a fee schedule. In one example, the lost revenue opportunity may be determined based upon an identified iUnits value in the target billing data table multiplied by a payment rate (e.g., a dollar amount, a price, etc.) obtained from a fee schedule. For example, the tool V 162 may parse the filtered target billing data to identify an iUnits value for a billing record. The iUnits may, for example, be the amount of medication and/or product the provider billed in the record. The tool V 160 may access a fee schedule that outlines payment rates for various medications and/or products for the corresponding provider. The tool V 162 may calculate, using the identified iUnits value and the accessed payment rate, a lost revenue opportunity for that billing record included in the target billing data table.

Alternatively and/or additionally, at step 608, a lost revenue opportunity may be determined for the filtered target billing data based upon a PAF data point. PAF represents a “Percent of Fee” which is specified by a payer. In one example, the lost revenue opportunity may be determined using an amount corresponding to a medication and/or product dispense charge (“T_DispChgAmt”) identified in the target billing data table. The tool V 162 may access tables and identify a corresponding PAF data point. The tool V 162 may calculate, using the identified T_DispChgAmt and the accessed PAF, a lost revenue opportunity for that billing record included in the target billing data table. For example, a lost revenue opportunity=T_DispChgAmt×PAF.

The calculated lost revenue opportunity may be reported to the healthcare provider computer 102, as describe in FIG. 11. However, in certain example embodiments, if the calculated lost revenue opportunity is less than a set dollar amount (i.e., $5, $10, $25, or any desired amount), then the potential revenue opportunity may be excluded and not reported to the healthcare provider computer 102. While method 600 is described using certain filters and/or business rules, it is to be appreciated that some filters and/or business rules may be removed and/or added to enhance the lost revenue opportunity results. The method 600 may end after step 608.

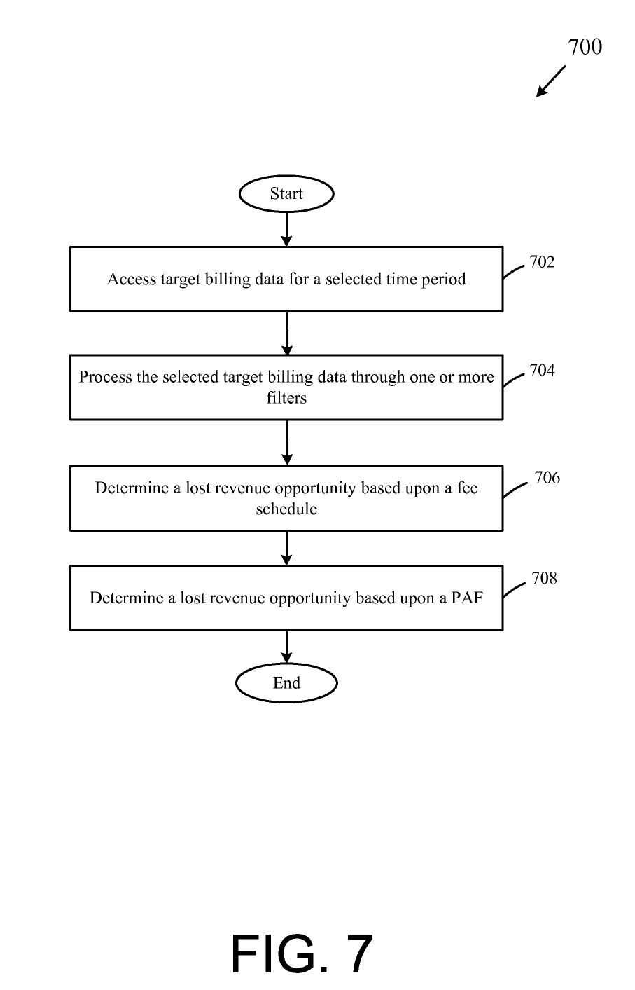

FIG. 7 is a flow chart illustrating an example method 700 for determining lost revenue for a medication and/or product as a result of failure to enter required billing data as a part of an outpatient pharmacy transaction, according to an example embodiment of the disclosure. Referring now to FIGS. 1A, 1B, and 7, the exemplary method 700 begins at the START step and continues to step 702, where a service provider computer, such as service provider computer 104, may access target billing data for a selected time period (e.g., a day, a week, a month, two months, first quarter, second quarter, January, June, 2012, or any other desired time period) in the target billing data file 154. In one example, the service provider computer 104 accesses the target billing data that were stored in the target billing data tables in step 212 of FIG. 2.

At step 704, the service provider computer 104 may process the target billing data through one or more filters. In one example, the service provider computer 104 may employ a tool VI 164 of the ROT module 144. The tool VI 164 may engage one or more tool VI filters 188 to filter the target billing data to remove one or more billing records that may not be used by the tool VI 164 during a determination of a lost revenue opportunity. The one or more tool VI filters 188 may include, without limitation, a rev code filter to identify a billing code, a HCPCS filter to identify one or more billing records that are missing an HCPCS code, a patient type filter to identify a patient as either an inpatient type or an outpatient type, and/or a payer filter to identify one or more particular payers (e.g., via BIN Number, BIN Number and PCN or BIN Number and Group ID). The example rev code filter may identify a billing record in the target billing data table that utilizes a billing code Rev636. The HCPCS filter may identify one or more billing records in the target billing data table that do not include a HCPCS code. As described herein, HCPCS—Healthcare Common Procedure Coding System—includes a set of healthcare procedure codes utilized by the ROT module 144 to determine lost revenue opportunities. The patient type filter may identify whether the patient, at the time of service, was categorized as an outpatient. For example, the patient type filter may parse the target billing data to identify a patient type (i.e., inpatient or outpatient). The payer filter may identify those payer(s) that are non-Medicaid payer(s). Data identified in the target billing data table as satisfying, at least, each of the tool VI filters 184, may be further processed in step 706.

Processing of the data identified in step 704 may further include an application of one or more business rules, for example, one or more tool VI business rules 190. It is to be appreciated that the one or more tool VI business rules 190 may be applied sequentially or concurrently during processing. However, for discussion purposes, the business rules will be described as being applied to the identified data sequentially.

At step 706, a lost revenue opportunity may be calculated using a fee schedule. In one example, the lost revenue opportunity may be determined based upon an identified iUnits value in the target billing data table multiplied by a payment rate obtained from a fee schedule. For example, the tool VI 164 may parse the filtered target billing data to identify an iUnits. The iUnits may, for example, be the amount of medication and/or product the provider billed in the record. The tool VI 164 may access a fee schedule that outlines payment rates for various medications and/or products for the corresponding provider. The tool VI 164 may calculate, using the identified iUnits value and the accessed payment rate, a lost revenue opportunity for that billing record included in the target billing data table.

Alternatively and/or additionally, at step 708, a lost revenue opportunity may be calculated using a PAF data point. In one example, the lost revenue opportunity may be determined using an amount corresponding to a medication and/or product dispense charge (“T_DispChgAmt”) identified in the target billing data table. The tool VI 164 may access a PAF tables and identify a corresponding PAF data point. The tool VI 164 may calculate, using the identified T_DispChgAmt and the accessed PAF, a lost revenue opportunity for that billing record included in the target billing data table. For example, a lost revenue opportunity=T_DispChgAmt×PAF.

The calculated lost revenue opportunity may be reported to the healthcare provider computer 102, as describe in FIG. 11. However, if the calculated lost revenue opportunity is less than a set dollar amount (i.e., $5, $10, $25, or any desired amount), then the potential revenue opportunity may be excluded and not reported to the healthcare provider computer 102. While method 700 is described using certain filters and/or business rules, it is to be appreciated that some filters and/or business rules may be removed and/or added to enhance the lost revenue opportunity results. The method 700 may end after step 708.

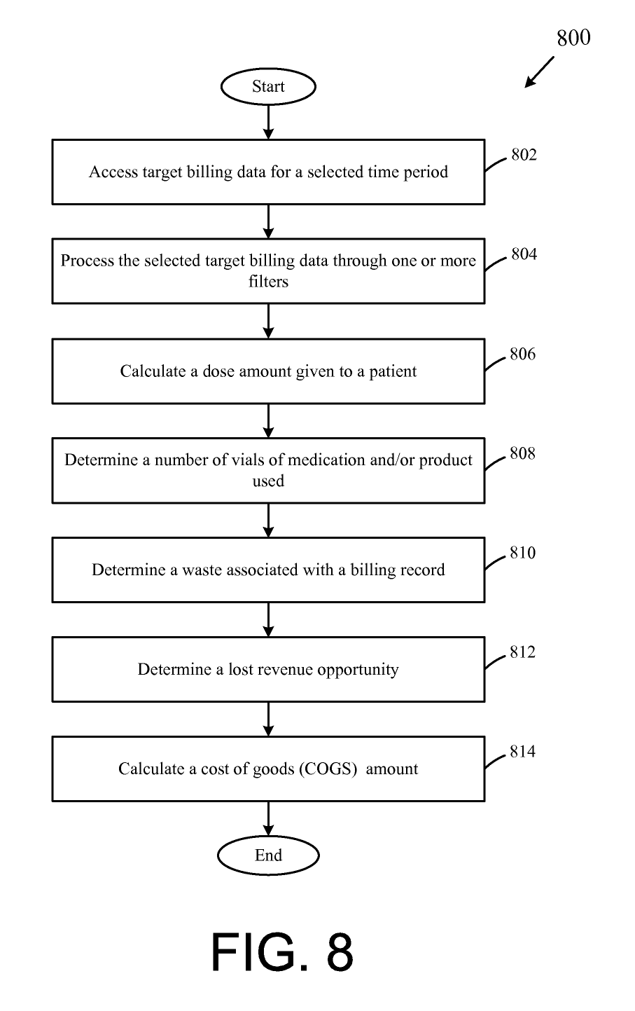

FIG. 8 is a flow chart illustrating an example method 800 for determining lost revenue for a medication and/or product discarded by a provider and subsequently not billed as a part of an outpatient pharmacy transaction, according to an example embodiment of the disclosure. Referring now to FIGS. 1A, 1B, and 8, the exemplary method 800 begins at the START step and continues to step 802, where a service provider computer, such as service provider computer 104, may access target billing data for a selected time period (e.g., first quarter, second quarter, January, June, 2012, etc.) in the target billing data file 154. In one example, the service provider computer 104 accesses the target billing data that were stored in the target dispensing data tables and target billing data tables in step 212 of FIG. 2.

At step 804, the service provider computer 104 may process the target billing data through one or more filters. In one example, the service provider computer 104 may employ a tool VII 166 of the ROT module 144. The tool VII 166 may engage one or more tool VII filters 192 to filter the target billing data to remove one or more billing records that may not be used by the tool VII 166 during a determination of a lost revenue opportunity. The one or more tool VII filters 192 may include, without limitation, a patient type filter to identify a patient as either an inpatient type or an outpatient type, and/or a drug filter to identify one or more particular medications (e.g., via NDC code or RxNorm number). The patient type filter may identify whether the patient, at the time of service, was categorized as an outpatient. For example, the patient type filter may parse the target billing data to identify a patient type (i.e., inpatient or outpatient) associated with a pharmacy transaction. The drug filter may, in one example, include one or more sub-filters. For example, the drug filter may include a first sub-filter to identify one or more HCPCS codes in the target billing data table that are associated with a medication and/or drug that may be purchased in a single dose vial (SDV). The drug filter may also include a second sub-filter to identify one or more HCPCS codes in the target billing data table that correspond to a single NDC. The drug filter may include a third sub-filter to identify HCPCS codes in the target billing data table that correspond to multiple NDCs, but where each NDC has the same bill unit quantity. Data identified in the target billing data table as satisfying, at least, each of the tool VII filters 192, will be further processed in step 806.

Processing of the data identified in step 804 may further include an application of one or more business rules, for example, one or more tool VII business rules 194. It is to be appreciated that the one or more tool VII business rules 194 may be applied sequentially or concurrently during processing. However, for discussion purposes, the business rules will be described as being applied to the identified data sequentially.

At step 806, processing may continue with application of a business rule to filtered data from step 804, to calculate a dose amount given to a patient. In one example, the dose amount may be calculated using an identified iUnits value in the target billing data multiplied by a HCPCS bill unit value obtained from the HCPCS NDC table 150. For example, the tool VII 166 may parse the filtered target billing data from step 804 to identify an iUnits value for a billing record. The iUnits may, for example, be the amount of medication and/or product the provider billed in the record. The tool VII 166 may also parse the filtered target billing data to identify a HCPCS entry. The tool VII 166 may access the HCPCS NDC table 150 and compare the bill units corresponding to the identified HCPC. For example, the HCPCS entry may be procedure code 1-J0585 and may be a per unit code.

At step 808, a business rule may be applied to determine a number of vials of medication and/or product used. In one example, the number of vials used may be determined by the tool VII 166 by calculating:

$$\# of vials used = \frac{CalcDoseAmtGiven ( from step 806 )}{( \# of HCPCS Bill Units ) \times HCPCS bill unit )}$$

The values corresponding to the number of HCPCS Bill Units and the HCPCS bill unit may be accessed by the tool VII 166 from the HCPCS NDC table 150. The calculated number of vials used may be rounded to the nearest whole number and equates to the number of vials that should have been billed for that particular billing record.

At step 810, processing may continue with application of a business rule to determine a waste associated with the billing record. In one example, the tool VII 166 may take the difference between the number of vials used rounded to the nearest whole number and the number of vials used calculated at step 808, and multiple the difference by the number of HCPCS Bill Units. For example, the calculation may be:

Waste=(# of vials used rounded up—# of vials used)×(# HCPCS Bill Units)

At step 812, a lost revenue opportunity may be determined for the waste calculated at step 810. In one example, the tool VII 166 may determine the lost revenue opportunity by multiplying the waste determined at step 810 by a corresponding pay rate. The pay rate may be accessed, for example, from a fee schedule.

At step 814, processing may continue with application of a business rule including the calculation of a cost of goods sold (COGS) amount. A COGS amount may associated with a situation where a provider has re-used leftover drug from a single dose vial (e.g., batching) for the administration to other patients in the same day. For situations where this has occurred, the tool VII 166 may calculate a COGS amount and subtract this amount from the lost revenue opportunity calculated at step 812. In one example, the COGS amount may be determined using dispensing data. For example, the tool VII 166 may identify the number of times a drug was dispensed each day and calculate the total number of vials batched compared to the number of vials if not batched, where the aggregate difference is the number of vials saved per day. The tool VII 166 may take the number of vials saved multiplied by the net acquisition cost for the vial to determine the COGS saved.

The calculated lost revenue opportunity may be reported to the healthcare provider computer 102, as describe in FIG. 11. However, if the calculated lost revenue opportunity is less than a set dollar amount (i.e., $5, $10, $25, or any desired amount), then the potential revenue opportunity may be excluded and not reported to the healthcare provider computer 102. While method 800 is described using certain filters and/or business rules, it is to be appreciated that some filters and/or business rules may be removed and/or added to enhance the lost revenue opportunity results. The method 800 may end after step 814.

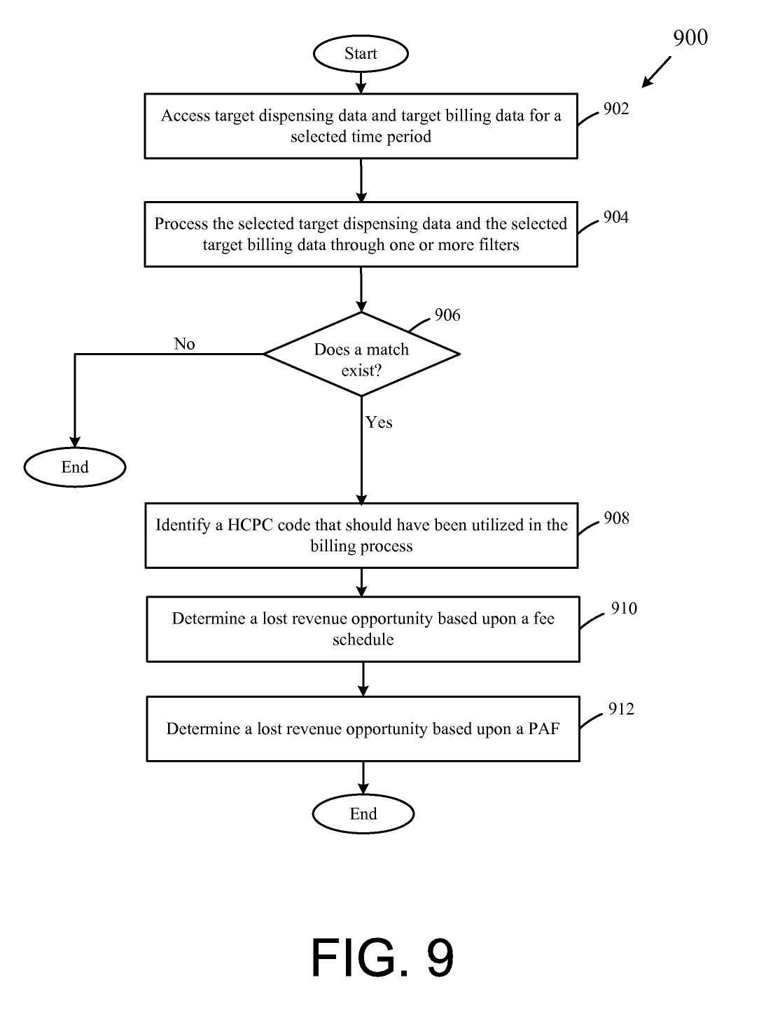

FIG. 9 is a flow chart illustrating an example method 900 for determining lost revenue for a medication and/or product that was dispensed but not properly coded as a part of an outpatient pharmacy transaction, according to an example embodiment of the disclosure. Referring now to FIGS. 1A, 1B, and 9, the exemplary method 900 begins at the START step and continues to step 902, where a service provider computer, such as service provider computer 104, may access target dispensing data and target billing data for a selected time period (e.g., first quarter, second quarter, January, June, 2012, etc.) in the target prescription data file 152 and the target billing data file 154. In one example, the service provider computer 104 accesses the target dispensing data and target billing data that was stored in the target dispensing data tables and target billing data tables in step 212 of FIG. 2.

At step 904, the service provider computer 104 may process the target dispensing data and the target billing data through one or more filters. In one example, the service provider computer 104 may employ a tool X 168 of the ROT module 144. The tool X 168 may engage one or more tool X filters 196 to filter the target dispensing data and the target billing data to remove one or more dispense records and one or more billing records that may not be used by the tool X 168 during a determination of a lost revenue opportunity. The one or more tool X filters 196 may include, without limitation, a patient type filter to identify a patient as either an inpatient type or an outpatient type, a payer filter to identify one or more particular payers (e.g., via BIN Number, BIN Number and PCN or BIN Number and Group ID), and/or a drug filter to identify one or more particular medications (e.g., via NDC code or RxNorm number). The patient type filter may identify whether the patient, at the time of service, was categorized an outpatient. For example, the patient type filter may parse the target dispensing data and/or the target billing data to identify a patient type (i.e., inpatient or outpatient). The payer filter may identify those payer(s) that are non-Medicaid payer(s). And, the drug filter may, in one example, identify prescription data and billing data corresponding to non-target drugs. In one example, a non-target drug may include, without limitation, a miscellaneous HCPCS code(s). Prescription data and billing data identified in the target billing data and the target dispensing data as satisfying, at least, each of the tool X filters 196, will be further processed in step 906.

Processing of the data identified in step 904 may further include an application of one or more business rules, for example, one or more tool X business rules 197. It is to be appreciated that the one or more tool X business rules 197 may be applied sequentially or concurrently during processing. However, for discussion purposes, the business rules will be described as being applied to the identified data sequentially.

At step 906, processing may continue with application of a business rule to the filtered data identified in step 904 to determine whether a match exists between a dispense event and a bill event for a selected time period (e.g., a day, a wee, a month, first quarter, second quarter, January, June, 2012, etc.). For example, the tool X 168 may parse the filtered target dispensing data and the filtered target billing data to determine whether a match exists between a dispense event and a bill event. The match may, for example, be based at least in part upon a patient identifier (e.g., an MRN), such that an MRN identified in the prescription dispense target event is also identified in the prescription billing target event. If a match is not identified, the NO branch is followed and the process may end. If a match is identified, the YES branch is followed and processing may proceed to step 908.

At step 908, processing may continue with application of a business rule to identify a HCPCS code that should have been utilized for the billing event. In one example, the tool X 168 may parse the target billing data to identify a code, for example a HCPCS code, corresponding to a medication that was dispensed as represented in the corresponding target dispensing data. The tool X 168 may compare the identified NDC code to the HCPCS NDC table to identify a corresponding HCPCS code.

At step 910, processing may continue to determine a lost revenue opportunity based upon a fee schedule. In one example, the lost revenue opportunity may be determined based upon an identified iUnits value in the target billing data table multiplied by a payment rate obtained from a fee schedule. For example, the tool X 168 may parse the data identified in step 904 to identify an iUnits value for a billing record. The iUnits may, for example, be the amount of medication and/or product the provider billed in the record. The tool X 168 may access a fee schedule that outlines payment rates corresponding to a provider and various HCPCS codes. The tool X 168 may calculate, using the identified iUnits value and the accessed payment rate, a lost revenue opportunity for that billing record included in the target billing data table.

Alternatively and/or additionally, at step 912, a lost revenue opportunity may be determined for the data identified in step 706 based upon a PAF data point. In one example, the lost revenue opportunity may be determined using an amount corresponding to a medication and/or product dispense charge (“T_DispChgAmt”) identified in the target billing data table. The tool X 164 may access a PAF tables and identify a corresponding PAF data point. The tool X 164 may calculate, using the identified T_DispChgAmt and the accessed PAF, a lost revenue opportunity for that billing record included in the target billing data table. For example, a lost revenue opportunity=T_DispChgAmt×PAF.

The calculated lost revenue opportunity may be reported to the healthcare provider computer 102, as describe in FIG. 11. However, if the calculated lost revenue opportunity is less than a set dollar amount (i.e., $5, $10, $25, or any desired amount), then the potential revenue opportunity may be excluded and not reported to the healthcare provider computer 102. While method 900 is described using certain filters and/or business rules, it is to be appreciated that some filters and/or business rules may be removed and/or added to enhance the lost revenue opportunity results. The method 900 may end after step 912.

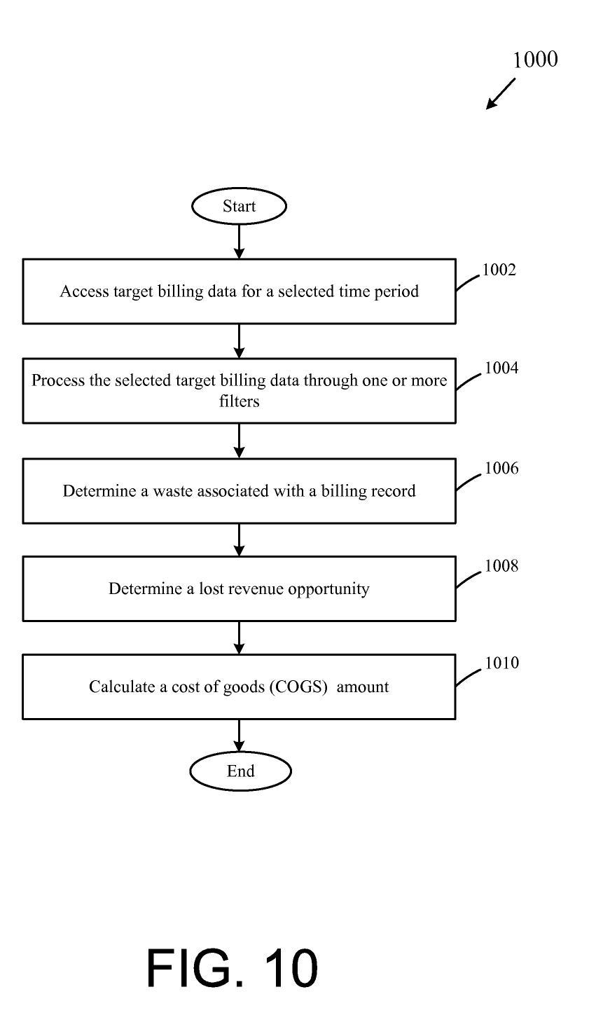

FIG. 10 is a flow chart illustrating an example method 1000 for determining lost revenue for a medication and/or product discarded by a provider and subsequently not billed as a part of an outpatient pharmacy transaction, according to an example embodiment of the disclosure. Referring now to FIGS. 1A, 1B, 2, and 10, the exemplary method 1000 begins at the START step and continues to step 1002, where a service provider computer, such as service provider computer 104, may access target billing data for a selected time period (e.g., first quarter, second quarter, January, June, 2012, etc.) in the target billing data file 154. In one example, the service provider computer 104 accesses the target billing data that were stored in the target dispensing data tables and target billing data tables in step 212 of FIG. 2.

At step 1004, the service provider computer 104 may process the target billing data table through one or more filters. In one example, the service provider computer 104 may employ a tool XI 170 of the ROT module 144. The tool XI 170 may engage one or more tool XI filters 198 to filter the target dispensing data and the target billing data to remove one or more dispense records and one or more billing records that may not be used by the tool XI 170 during a determination of a lost revenue opportunity. The one or more tool XI filters 198 may include, without limitation, a patient type filter to identify a patient as either an inpatient type or an outpatient type and/or a drug filter to identify one or more particular medications (e.g., via NDC code or RxNorm number). The patient type filter may identify whether the patient, at the time of service, was categorized as an outpatient. For example, the patient type filter may parse the target billing data to identify a patient type (i.e., inpatient or outpatient). The drug filter may, in one example, include one or more sub-filters. For example, the drug filter may include a first sub-filter to identify one or more HCPCS codes in the target billing data table that are associated with a medication and/or drug that may be purchased in a single dose vial (SDV). The drug filter may include a second sub-filter to identify one or more HCPCS codes in the target billing data table that correspond to multiple NDCs and multiple ASP billing units. Data identified in the target billing data table as satisfying, at least, each of the tool XI filters 198, will be further processed in step 1006.

Processing of the data identified in step 1004 may further include an application of one or more business rules, for example, one or more tool XI business rules 199. It is to be appreciated that the one or more tool XI business rules 199 may be applied sequentially or concurrently during processing. However, for discussion purposes, the business rules will be described as being applied to the identified data sequentially.

At step 1006, processing may continue with application of a business rule to the filtered data from step 1004 to perform a waste calculation. In one example, waste calculation may be a multi-step calculation. For example, a waste calculation may include, without limitation:
Step 1: iUnits/Minimum bill units (rounded to the nearest whole number)×Minimum bill units=Number of units that should have been billed
Step 2: Number of units that should have been billed−iUnits=Waste
Step 3: Access purchase data for the provider and parse the purchase data to identify all NDCs associated with HCPCS, if there are no purchases for all NDCs with the same bill unit for a specific HCPCS, exclude this bill unit from the calculation.
Step 4: If any of the remaining minimum bill units produce a waste of 0, exclude the entire HCPCS from the calculation.
Step 5: If there are no purchases for any NDC associated with a HCPCS of 1, exclude the entire HCPCS from the calculation.
Step 6: If multiple bill units still exist for a HCPCS, assume the one with the lowest amount of waste to calculate a lost revenue opportunity.

At step 1008, a lost revenue opportunity may be determined for the waste calculated at step 1006. In one example, the tool XI 170 may determine the lost revenue opportunity by multiplying the waste determined at step 1006 by a corresponding pay rate (e.g., fee schedule).

At step 1010, processing may continue with application of a business rule including the calculation of a cost of goods (COGS) amount. A COGS amount may associated with a situation where a provider has re-used leftover drug (e.g., batching) for the administration to other patients in the same day. For situations where this has occurred, the tool XI 170 may calculate a COGS amount and subtract this amount from the lost revenue opportunity calculated at step 1008. In one example, the COGS amount may be determined using dispensing data. For example, the tool XI 170 may identify the number of times a drug was used each day and calculate the number of vials batched and the number of vials not batched, where the difference is the number of vials saved. The tool XI 170 may take the number of vials saved multiplied by the net acquisition cost for the vial to determine the COGS saved.

The calculated lost revenue opportunity may be reported to the healthcare provider computer 102, as describe in FIG. 11. However, if the calculated lost revenue opportunity is less than a set dollar amount (i.e., $5, $10, $25, or any desired amount), then the potential revenue opportunity may be excluded and not reported to the healthcare provider computer 102. While method 800 is described using certain filters and/or business rules, it is to be appreciated that some filters and/or business rules may be removed and/or added to enhance the lost revenue opportunity results. The method 1000 may end after step 1010.

FIG. 11 is a flow chart illustrating an example method 1100 for generating and/or communicating a lost revenue report that may include lost revenue opportunities to the healthcare provider computer, according to an example embodiment of the disclosure. Referring now to FIGS. 1A-10, the exemplary method 1100 begins at the START step and continues to step 1102, where a service provider computer, such as service provider computer 104, may access one or more lost revenue opportunities calculated by the ROT module 144. For example, as described in FIG. 1B, the ROT module 144 may include, without limitation, one or more revenue opportunity tools such as tool II, tool III, tool IV, tool V, tool VI, tool VII, tool X, and tool XI. Each of the tools, as described with respect to FIGS. 3-10, may access target data and perform a lost revenue opportunity calculation to determine whether one or more billing events associated with a provider for the selected time period may have missed a billing opportunity, incorrectly billed, and/or missed an opportunity to bill for waste.

At step 1104, the service provider computer 104 may process the one or more lost revenue opportunities to remove duplicates from the tool(s) outputs. For example, the service provider computer 104 may run one or more stored procedures, such as, for example, RAAM.usp_Tool_RemoveDuplicatesFromToolResults, to remove duplicate opportunities that may have been determined throughout the various calculations. At step 1106, the service provider computer 104 may compile the lost revenue opportunities and facilitate storage of the lost revenue opportunity results. In one example, the stored lost revenue opportunities may be stored as a list and/or a lost revenue report that may include lost the lost revenue opportunities, the corresponding selected time period, and/or the corresponding target billing data and/or target dispensing data. At step 1108, the service provider computer 104 may communicate the lost revenue report to the healthcare provider computer 102. The lost revenue report may be communicated electronically (e.g., via email, text, etc.), and/or the results may be printed out and sent to a provider associated with the healthcare provider computer 102. The method 1100 may end after step 1108.

Accordingly, example embodiments disclosed herein can provide the technical effects of creating systems and methods that provide a way to determine and communicate lost revenue opportunities, such as those associated with a missed billing opportunity, incorrect billing, and/or missed opportunity to bill for waste, that may be available for a healthcare provider. While the exemplary embodiments described herein disclose certain steps occurring at the service provider computer 104 and/or the ROT module 144, in alternative embodiments those steps described with reference to FIGS. 1-11 may alternately be completed at the healthcare provider computer 102, a processor driven device separate and distinct from the healthcare provider computer 102 and the service provider computer 104, and/or any combination of those devices along with the service provider computer 104. In those alternate embodiments, certain transmission/receiving steps described above with reference to FIGS. 1-11 may be omitted while others may be added, as understood by one of ordinary skill in the art. The intent being that in alternate embodiments, any of the devices/computers discussed in FIG. 1A are capable of completing any or any part of the methods described with reference to FIGS. 2-11.

Various block and/or flow diagrams of systems and methods and/or computer program products according to example embodiments are described above. It will be understood that one or more blocks of the block diagrams and flow diagrams, and combinations of blocks in the block diagrams and flow diagrams, respectively, can be implemented by computer-executable program instructions. Likewise, some blocks of the block diagrams and flow diagrams may not necessarily need to be performed in the order presented, or may not necessarily need to be performed at all, according to some embodiments.

These computer-executable program instructions may be loaded onto a special purpose computer or other particular machine, a processor, or other programmable data processing apparatus to produce a particular machine, such that the instructions that execute on the computer, processor, or other programmable data processing apparatus create means for implementing one or more functions specified in the flowchart block or blocks. These computer program instructions may also be stored in a computer-readable memory that can direct a computer or other programmable data processing apparatus to function in a particular manner, such that the instructions stored in the computer-readable memory produce an article of manufacture including instruction means that implement one or more functions specified in the flow diagram block or blocks. As an example, embodiments of the disclosure may provide for a computer program product, that includes a computer usable medium (e.g., transitory or non-transitory) having a computer-readable program code or program instructions embodied therein, said computer-readable program code adapted to be executed to implement one or more functions specified in the flow diagram step or steps. The computer program instructions may also be loaded onto a computer or other programmable data processing apparatus to cause a series of operational elements or steps to be performed on the computer or other programmable apparatus to produce a computer-implemented process such that the instructions that execute on the computer or other programmable apparatus provide elements or steps for implementing the functions specified in the flow diagram step or steps.

Accordingly, blocks of the block diagrams and flow diagrams support combinations of means for performing the specified functions, combinations of elements or steps for performing the specified functions and program instruction means for performing the specified functions. It will also be understood that each block of the block diagrams and flow diagrams, and combinations of blocks in the block diagrams and flow diagrams, can be implemented by special-purpose, hardware-based computer systems that perform the specified functions, elements or steps, or combinations of special purpose hardware and computer instructions.

Many modifications and other embodiments of those set forth herein will be apparent having the benefit of the teachings presented in the foregoing descriptions and the associated drawings. Therefore, it is to be understood that the disclosure is not to be limited to the specific embodiments disclosed and that modifications and other embodiments are intended to be included within the scope of the appended claims. Although specific terms are employed herein, they are used in a generic and descriptive sense only and not for purposes of limitation.

That which is claimed is:

1. A computer-implemented method, comprising:
receiving, by one or more computers comprising one or more processors from a healthcare provider computer, dispensing data and billing data for a plurality of healthcare transactions and for a selected time period;
identifying, by the one or more computers, one or more data events corresponding to both the dispensing data and the billing data, or corresponding to only the billing data; and
determining, by the one or more computers, one or more lost revenue opportunities for the identified one or more data events.

2. The computer-implemented method of claim 1, wherein the identifying, by the one or more computers, the one or more data events corresponding to both the dispensing data and the billing data, or corresponding to only the billing data comprises:
applying, by the one or more computers, one or more filters to the dispensing data or the billing data, wherein the one or more filters include at least one of a payer filter, a patient type filter, a drug filter, a code filter, or a record type filter.

3. The computer-implemented method of claim 1 further comprising:
generating, by the one or more computers, a lost revenue opportunity report comprising the determined one or more lost revenue opportunities; and
transmitting, by the one or more computers to the healthcare provider computer, the lost revenue report.

4. The computer-implemented method of claim 1, wherein determining, by the one or more computers, one or more lost revenue opportunities for the identified data events comprises applying one or more business rules to the filtered dispensing data or the filtered billing data, wherein each of the one or more business rules comprise a calculation for a lost revenue opportunity.

5. The computer-implemented method of claim 4, wherein if the identifying, by the one or more computers, one or more data events corresponds to both the dispensing data and the billing data, the one or more business rules comprises at least automatically determining whether a match exists between a dispense event in the dispensing data and a billing event in the billing data, wherein the match is based at least in part on a patient identifier.

6. The computer-implemented method of claim 4, wherein determining, by the one or more computers, the one or more lost revenue opportunities for the identified data events further comprises:
accessing, by the one or more computers, Healthcare Common Procedure Coding (HCPC) data from at least one of a Healthcare Common Procedure Coding System (HCPCS) code table and a HCPCS National Drug Code (NDC) table; and
applying, by the one or more computers, the one or more business rules to the identified data events to calculate the lost revenue opportunity, wherein the one or more business rules utilize at least HCPCS data accessed from one or more of the HCPCS code table and the HCPCS NDC table.

7. The computer-implemented method of claim 1 further comprising excluding, by the one or more computers, one or more lost revenue opportunities that do not meet a minimum revenue opportunity threshold.

8. The computer-implemented method of claim 1, wherein the healthcare transaction is an outpatient pharmacy transaction

9. The computer-implemented method of claim 1, wherein the selected time period is quarterly and the dispensing data and the billing data are received in response to a request transmitted by the one or more computers to the healthcare provider computer.

10. The computer-implemented method of claim 1, wherein one of the one or more lost revenue opportunities corresponds to a waste opportunity, wherein the waste opportunity is determined at least in part on a waste opportunity calculation less a cost of goods sold amount.

11. A system comprising:
at least one memory operable to store computer-executable instructions; and
at least one processor configured to access the at least one memory and execute the computer-executable instructions to:
receive dispensing data and billing data for a plurality of healthcare transactions and for a selected time period from a healthcare provider computer;
identify one or more data events corresponding to both the dispensing data and the billing data, or corresponding to only the billing data; and
determine one or more lost revenue opportunities for the identified one or more data events.

12. The system of claim 11, wherein the at least one or more processors configured to execute the computer-executable instructions to identify the one or more data events corresponding to both the dispensing data and the billing data, or corresponding to only the billing data comprises:
apply one or more filters to the dispensing data or the billing data, wherein the one or more filters include at least one of a payer filter, a patient type filter, a drug filter, a code filter, or a record type filter.

13. The system of claim 11, wherein the at least one or more processors configured are further configured to execute the computer-executable instructions to:
generate a lost revenue opportunity report comprising the determined one or more lost revenue opportunities; and
transmit the lost revenue report to the healthcare provider computer.

14. The system of claim 11, wherein the at least one or more processors configured to execute the computer-executable instructions to determine one or more lost revenue opportunities for the identified data events compare further configured to execute computer-executable instructions to apply one or more business rules to the filtered dispensing data or the filtered billing data, wherein each of the one or more business rules comprise a calculation for a lost revenue opportunity.

15. The system of claim 14, wherein if the if the identified one or more data events corresponds to both the target dispensing data table and the target billing data table, the one or more business rules comprises at least automatically determining whether a match exists between a dispense event in the dispensing data and a billing event in the billing data, wherein the match is based at least in part on a patient identifier.

16. The system of claim 14, wherein the at least one or more processors configured to execute the computer-executable instructions to determine one or more lost revenue opportunities for the identified data events are further configured to execute computer-executable instructions to:
access Healthcare Common Procedure Coding (HCPC) data from at least one of a Healthcare Common Procedure Coding System (HCPCS) code table and a HCPCS National Drug Code (NDC) table; and
apply the one or more business rules to the identified data events to calculate the lost revenue opportunity, wherein the one or more business rules utilize at least HCPCS data accessed from one or more of the HCPCS code table and the HCPCS NDC table.

17. The system of claim 11, wherein the at least one or more processors configured are further configured to execute the computer-executable instructions to exclude one or more lost revenue opportunities that do not meet a minimum revenue opportunity threshold.

18. The system of claim 11, wherein the healthcare transaction is an outpatient pharmacy transaction.

19. The system of claim 11, wherein the selected time period corresponds to a quarterly review and the dispensing data and the billing data is received in response to a request transmitted by the one or more computers to the healthcare provider computer.

20. The system of claim 11, wherein, wherein one of the one or more lost revenue opportunities corresponds to a waste opportunity, wherein the waste opportunity is determined at least in part on a waste opportunity calculation less a cost of goods amount.
